(19) United States
(12) Patent Application Publication
(10) Pub. No.: US 2026/0089563 A1
(43) Pub. Date: Mar. 26, 2026

(54) SYSTEM AND METHOD FOR OPTIMIZING NETWORK PROTOCOL LAYER FUNCTIONALITY OF A NETWORK

(71) Applicant: Samsung Electronics Co., Ltd., Suwon-si (KR)

(72) Inventors: Aneesh Narendra DESHMUKH, Bangalore (IN); Mayank SONU, Bangalore (IN); Neha SHARMA, Bangalore (IN)

(21) Appl. No.: 19/403,490

(22) Filed: Nov. 28, 2025

Related U.S. Application Data
(63) Continuation of application No. PCT/KR2024/014024, filed on Sep. 13, 2024.

(30) Foreign Application Priority Data
Sep. 18, 2023 (IN) 202341062691
Sep. 10, 2024 (IN) 2023 41062691

(51) Int. Cl. H04W 28/06; H04L 5/00; H04L 47/34; H04W 80/02

(52) U.S. Cl. CPC H04W 28/065; H04L 5/0055; H04L 47/34; H04W 80/02

(57) ABSTRACT

A method and a system for optimizing the network protocol layer functionality of a network are provided. The method includes generating a packet data convergence protocol (PDCP) protocol data unit (PDU) based on a plurality of PDCP service data units (SDUs), by adding a first identifier associated with an identification of the PDCP PDU, generating a radio link control (RLC) PDU by adding an RLC header to the PDCP PDU, wherein the at least one segmentation of the RLC PDU is determined based on a grant related to the RLC PDU, and adding, based on the determination of the at least one segmentation of the RLC PDU, one from among the first identifier and a second identifier to each of the at least one segmentation of the RLC PDU.

### CROSS-REFERENCE TO RELATED APPLICATION(S)

This application is a continuation application, claiming priority under 35 U.S.C. § 365(c), of an International application No. PCT/KR2024/014024, filed on Sep. 13, 2024, which is based on and claims the benefit of an Indian Provisional patent application number 202341062691, filed on Sep. 18, 2023, in the Indian Intellectual Property Office, and of an Indian Complete patent application number 202341062691, filed on Sep. 10, 2024, in the Indian Intellectual Property Office, the disclosure of each of which is incorporated by reference herein in its entirety.

### BACKGROUND

### 1. Field

The disclosure relates to wireless communication networks. More particularly, the disclosure relates to a system and method for optimizing network protocol layer functionality of a network.

### 2. Description of Related Art

Background description includes information that may be useful in understanding the disclosure. It is not an admission that any of the information provided herein is prior art or relevant to the presently claimed disclosure, or that any publication specifically or implicitly referenced is prior art.

Nowadays, several broadband wireless technologies have been developed to meet a growing number of broadband subscribers by providing better applications and services. A second-generation (2G) wireless communication system has been developed to provide voice services while ensuring the mobility of users. A third generation (3G) wireless communication system supports not only voice services but also data services. In recent years, a fourth generation (4G) wireless communication system has been developed to provide high-speed data services. However, currently, the fourth generation (4G) or a long-term evolution (LTE) wireless communication system suffers from a lack of resources to meet the growing demand for high-speed data services. The lack of resources is addressed by the deployment of a fifth-generation (5G) wireless communication system to meet an ever-growing demand for high-speed data services. Furthermore, the 5G or a new radio (NR) wireless communication system provides ultra-reliability and supports low latency applications.

The above information is presented as background information only to assist with an understanding of the disclosure. No determination has been made, and no assertion is made, as to whether any of the above might be applicable prior art with regard to the disclosure.

### SUMMARY

Aspects of the disclosure are to address at least the above-mentioned problems and/or disadvantages and to provide at least the advantages described below. Accordingly, an aspect of the disclosure is to provide a system and method for optimizing network protocol layer functionality of a network.

Additional aspects will be set forth in part in the description which follows and, in part, will be apparent from the description, or may be learned by practice of the presented embodiments.

In accordance with an aspect of the disclosure, a method performed by a transmitter is provided. The method includes generating a packet data convergence protocol (PDCP) protocol data unit (PDU) based on a plurality of PDCP service data units (SDUs), by adding a first identifier associated with an identification of the PDCP PDU, generating a radio link control (RLC) PDU by adding an RLC header to the PDCP PDU, determining at least one segmentation of the RLC PDU, wherein the at least one segmentation of the RLC PDU is determined based on a grant related to the RLC PDU, and adding, based on the determination of the at least one segmentation of the RLC PDU, one from among the first identifier and a second identifier to each of the at least one segmentation of the RLC PDU.

In accordance with another aspect of the disclosure, a method performed by a receiver is provided. The method includes receiving a first category of data packets associated with lossless transmission from the transmitter, receiving a second category of data packets associated with a transmission loss from the transmitter, performing reassembly of a PDCP PDU at a PDCP network layer based on the received first category of data packets and the received second category of data packets, and generating a status PDCP PDU at the PDCP network layer for the second category of data packets.

In accordance with another aspect of the disclosure, a transmitter is provided. The transmitter includes a transceiver, memory, including one or more storage media, storing instructions, and at least one processor comprising processing circuitry, wherein the instructions, when executed by the at least one processor individually or collectively, cause the transmitter to generate a packet data convergence protocol (PDCP) protocol data unit (PDU) based on a plurality of PDCP service data units (SDUs)), by adding a first identifier associated with an identification of the PDCP PDU, generate a radio link control (RLC) PDU by adding an RLC header to the PDCP PDU, determine at least one segmentation of the RLC PDU, wherein the at least one segmentation of the RLC PDU is determined based on a grant related to the RLC PDU, and add, based on the determination of the at least one segmentation of the RLC PDU, one from among the first identifier and a second identifier to each of the at least one segmentation of the RLC PDU.

In accordance with another aspect of the disclosure, one or more non-transitory computer-readable storage media storing one or more computer programs including computer-executable instruction that, when executed by one or more processors of a transmitter individually or collectively, cause the transmitter to perform operations are provided. The operations include generating a packet data convergence protocol (PDCP) protocol data unit (PDU) based on a plurality of PDCP service data units (SDUs), by adding a first identifier associated with an identification of the PDCP PDU, generating a radio link control (RLC) PDU by adding an RLC header to the PDCP PDU, determining at least one segmentation of the RLC PDU, wherein the at least one segmentation of the RLC PDU is determined based on a grant related to the RLC PDU, and adding, based on the determination of the at least one segmentation of the RLC PDU, one from among the first identifier and a second identifier to each of the at least one segmentation of the RLC PDU.

Other aspects, advantages, and salient features of the disclosure will become apparent to those skilled in the art from the following detailed description, which, taken in conjunction with the annexed drawings, discloses various embodiments of the disclosure.

### BRIEF DESCRIPTION OF THE DRAWINGS

The above and other aspects, features, and advantages of certain embodiments of the disclosure will be more apparent from the following description taken in conjunction with the accompanying drawings, in which:

FIG. 1 illustrates a block diagram of a data plane in a LTE (4G) for packet processing according to an embodiment of the disclosure;

FIG. 2 illustrates a tabular representation of a sample header structure in LTE (4G) for a RLC layer according to an embodiment of the disclosure;

FIG. 3 illustrates a block diagram of a data plane in a NR (5G) for packet processing according to an embodiment of the disclosure;

FIG. 4 illustrates a tabular representation of a sample header structure in NR (5G) for an RLC layer according to an embodiment of the disclosure;

FIG. 5A illustrates a schematic diagram associated with a 5G radio access network (RAN) protocol stack for a user plane and control plane according to an embodiment of the disclosure;

FIG. 5B illustrates a schematic diagram associated with a layered processing of data packets in an NR network according to an embodiment of the disclosure;

FIG. 5C illustrates a schematic diagram associated with NR network architecture and interfaces according to an embodiment of the disclosure;

FIG. 6 illustrates a flowchart a placeholder functionality of a robust header compression (ROHC) processing performed on a data radio bearer (DRB) at a PDCP layer according to an embodiment of the disclosure;

FIG. 7 illustrates a system architecture in a form of a computer system according to an embodiment of the disclosure;

FIG. 8 a block diagram associated with a transmitter and receiver in a network according to an embodiment of the disclosure;

FIG. 9A illustrates a process flow associated with a transmission module for a generation of PDU for a data plane processing at a transmitter according to an embodiment of the disclosure;

FIG. 9B illustrates a schematic diagram associated with a generation of PDU for a data plane processing at a transmitter according to an embodiment of the disclosure;

FIG. 10 illustrates a process flow associated with a transmission module to configure modes for an RLC network layer at a transmitter according to an embodiment of the disclosure;

FIG. 11 illustrates a process flow associated with a re-transmission module for receiving status PDU to determine data packets to be retransmitted according to an embodiment of the disclosure;

FIG. 12 illustrates a process flow associated with a re-transmission module for retransmitting data packets at a transmitter according to an embodiment of the disclosure;

FIG. 13 illustrates a schematic diagram associated with retransmitting data packets at a transmitter according to an embodiment of the disclosure;

FIG. 14 illustrates a schematic diagram associated with a reassembly of retransmitted data packets at a receiver according to an embodiment of the disclosure;

FIG. 15A illustrates a process flow diagram associated with a header compression at a PDCP network layer according to an embodiment of the disclosure;

FIG. 15B illustrates a block diagram of a sample header structure for a F1-U interface between a PDCP and RLC layer according to an embodiment of the disclosure;

FIG. 16 illustrates a process flow diagram associated with a reception module to receive and rearrange data packets for a data plane processing at a receiver according to an embodiment of the disclosure;

FIG. 17 illustrates a process flow diagram associated with a reception module to rearrange data packets at a receiver for no loss of data packets in a network according to an embodiment of the disclosure;

FIG. 18 illustrates a schematic diagram associated with a rearrangement of data packets at a receiver for no loss of data packets in a network according to an embodiment of the disclosure;

FIG. 19 illustrates a process flow diagram associated with a reception module to rearrange data packets at a receiver for loss of data packets in a network according to an embodiment of the disclosure;

FIG. 20 illustrates a schematic diagram associated with a rearrangement of data packets at a receiver for loss of data packets in a network according to an embodiment of the disclosure;

FIG. 21 illustrates a process flow diagram associated with a status PDU generation module at a receiver according to an embodiment of the disclosure;

FIG. 22 illustrates a schematic diagram associated with status PDU generation at a receiver according to an embodiment of the disclosure;

FIG. 23 illustrates a tabular representation of a sample header structure for a control packet for a PDCP status report required for an automatic repeat request (ARQ) procedure according to an embodiment of the disclosure;

FIG. 24 illustrates a process flow associated with a re-transmission module for identical sequence number (SN) assigned to PDCP PDU and RLC PDU according to an embodiment of the disclosure;

FIG. 25 illustrates a schematic diagram associated with a generation of PDU for a data plane processing at a transmitter for identical SN assigned to PDCP PDU and RLC PDU according to an embodiment of the disclosure;

FIG. 26 illustrates a schematic diagram associated with a reassembly of data packets at a receiver for identical SN assigned to PDCP PDU and RLC PDU according to an embodiment of the disclosure;

FIG. 27 illustrates a schematic diagram associated with retransmitting data packets at a transmitter for identical SN assigned to PDCP PDU and RLC PDU according to an embodiment of the disclosure;

FIG. 28 illustrates a schematic diagram associated with retransmitting data packets at a transmitter for identical SN assigned to PDCP PDU and RLC PDU according to an embodiment of the disclosure; and

FIG. 29 illustrates a process flow comprising a method for optimizing a network protocol layer functionality of a network according to an embodiment of the disclosure.

Throughout the drawings, like reference numerals will be understood to refer to like parts, components, and structures.

### DETAILED DESCRIPTION

The following description with reference to the accompanying drawings is provided to assist in a comprehensive understanding of various embodiments of the disclosure as defined by the claims and their equivalents. It includes various specific details to assist in that understanding but these are to be regarded as merely exemplary. Accordingly, those of ordinary skill in the art will recognize that various changes and modifications of the various embodiments described herein can be made without departing from the scope and spirit of the disclosure. In addition, descriptions of well-known functions and constructions may be omitted for clarity and conciseness.

The terms and words used in the following description and claims are not limited to the bibliographical meanings, but, are merely used by the inventor to enable a clear and consistent understanding of the disclosure. Accordingly, it should be apparent to those skilled in the art that the following description of various embodiments of the disclosure is provided for illustration purpose only and not for the purpose of limiting the disclosure as defined by the appended claims and their equivalents.

It is to be understood that the singular forms “a,” “an,” and “the” include plural referents unless the context clearly dictates otherwise. Thus, for example, reference to “a component surface” includes reference to one or more of such surfaces.

In various examples of the disclosure described below, a hardware approach will be described as an example. However, since various embodiments of the disclosure may include a technology that utilizes both the hardware-based and the software-based approaches, they are not intended to exclude the software-based approach.

As used herein, the terms referring to merging (e.g., merging, grouping, combination, aggregation, joint, integration, unifying), the terms referring to signals (e.g., packet, message, signal, information, signaling), the terms referring to resources (e.g., section, symbol, slot, subframe, radio frame, subcarrier, resource element (RE), resource block (RB), bandwidth part (BWP), opportunity), the terms used to refer to any operation state (e.g., step, operation, procedure), the terms referring to data (e.g., packet, message, user stream, information, bit, symbol, codeword), the terms referring to a channel, the terms referring to a network entity (e.g., distributed unit (DU), radio unit (RU), central unit (CU), central unit-control plane (CU-CP), central unit-user plane (CU-UP), open radio access network (O-RAN) DU (O-DU), O-RAN RU (O-RU), O-RAN CU (O-CU), O-RAN CU-CP (O-CU-UP), O-RAN CU-CP (O-CU-CP)), the terms referring to the components of an apparatus or device, or the like are only illustrated for convenience of description in the disclosure. Therefore, the disclosure is not limited to those terms described below, and other terms having the same or equivalent technical meaning may be used therefor. Further, as used herein, the terms, such as ‘˜module’, ‘˜unit’, ‘˜part’, ‘˜body’, or the like may refer to at least one shape of structure or a unit for processing a certain function.

Further, throughout the disclosure, an expression, such as e.g., ‘above’ or ‘below’ may be used to determine whether a specific condition is satisfied or fulfilled, but it is merely of a description for expressing an example and is not intended to exclude the meaning of ‘more than or equal to’ or ‘less than or equal to’. A condition described as ‘more than or equal to’ may be replaced with an expression, such as ‘above’, a condition described as ‘less than or equal to’ may be replaced with an expression, such as ‘below’, and a condition described as ‘more than or equal to and below’ may be replaced with ‘above and less than or equal to’, respectively. Furthermore, hereinafter, ‘A’ to ‘B’ means at least one of the elements from A (including A) to B (including B). Hereinafter, ‘C’ and/or ‘D’ means including at least one of ‘C’ or ‘D’, that is, {‘C’, ‘D’, or ‘C’ and ‘D’}.

The disclosure describes various embodiments using terms used in some communication standards (e.g., 3^{rd} generation partnership project (3GPP), extensible radio access network (xRAN), open-radio access network (O-RAN) or the like), but it is only of an example for explanation, and the various embodiments of the disclosure may be easily modified even in other communication systems and applied thereto.

With the advent of a further increase in data demand, high bandwidth, and processing capability, next generation wireless communication systems, i.e., beyond the 5G and a sixth generation (6G) wireless communication system should be capable of meeting such ever-increasing requirements. As a result, a communication protocol should be capable of processing high-speed data. In the LTE, the protocols that exist for a user plane include a packet data convergence protocol (PDCP), a radio link control (RLC), a medium access control (MAC), and a physical protocol. A control plane stack additionally includes the radio resource control (RRC) and non-access stratum (NAS).

Further, the RLC protocol layer exists in user equipment (UE) and a base station or an Evolved Node B (eNB) and is a part of the LTE air interface control and data planes. The main functionalities of the RLC for the LTE (4G) are an error correction mechanism through an automatic repeat request (ARQ), an in-order delivery mechanism, a concatenation mechanism, a segmentation and reassembly mechanism, and a reordering mechanism.

It should be appreciated that the blocks in each flowchart and combinations of the flowcharts may be performed by one or more computer programs which include computer-executable instructions. The entirety of the one or more computer programs may be stored in a single memory device or the one or more computer programs may be divided with different portions stored in different multiple memory devices.

Any of the functions or operations described herein can be processed by one processor or a combination of processors. The one processor or the combination of processors is circuitry performing processing and includes circuitry like an application processor (AP, e.g., a central processing unit (CPU)), a communication processor (CP, e.g., a modem), a graphical processing unit (GPU), a neural processing unit (NPU) (e.g., an artificial intelligence (AI) chip), a wireless-fidelity (Wi-Fi) chip, a Bluetooth™ chip, a global positioning system (GPS) chip, a near field communication (NFC) chip, connectivity chips, a sensor controller, a touch controller, a finger-print sensor controller, a display drive integrated circuit (IC), an audio CODEC chip, a universal serial bus (USB) controller, a camera controller, an image processing IC, a microprocessor unit (MPU), a system on chip (SoC), an IC, or the like.

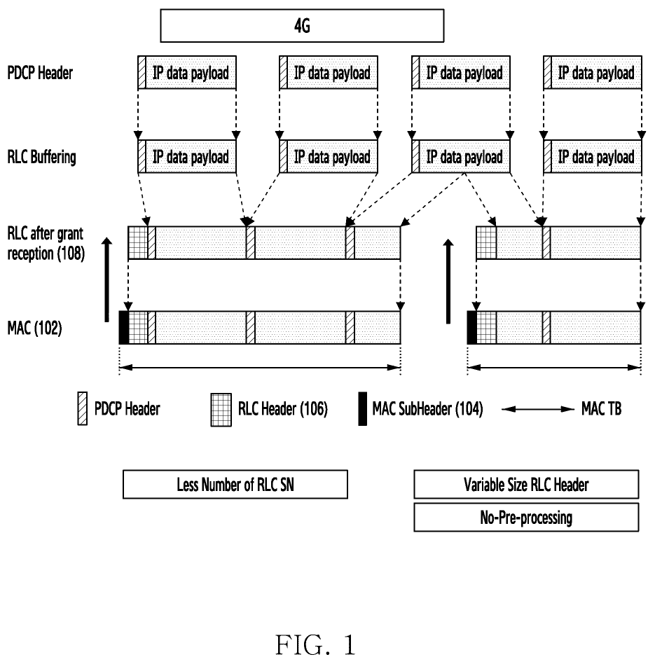

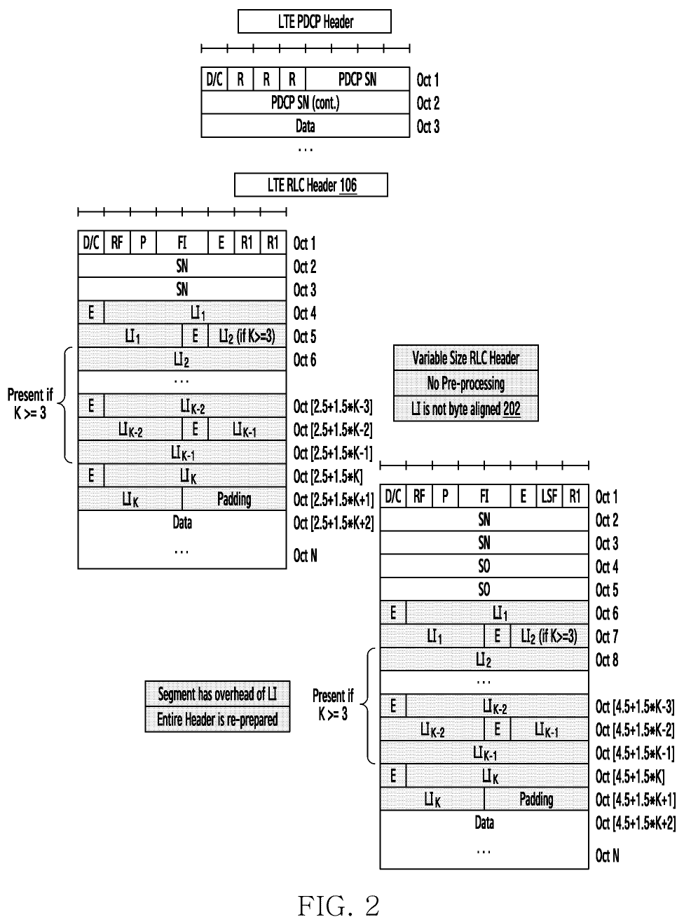

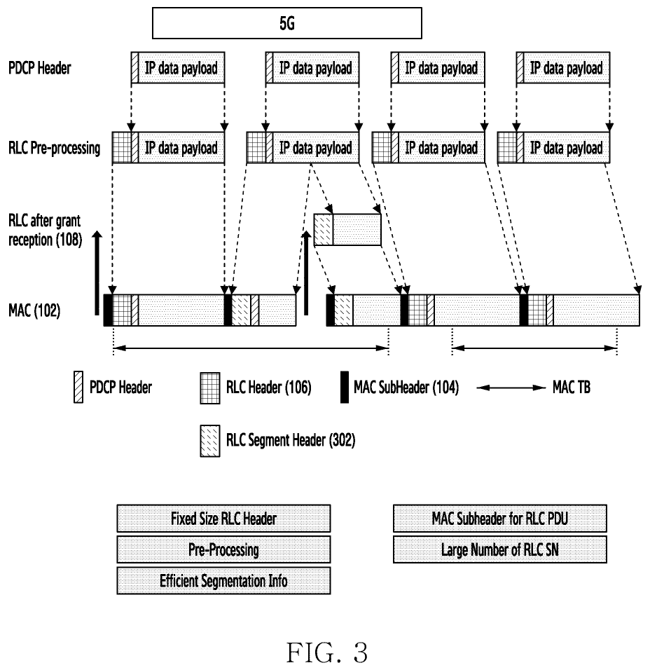

FIG. 1 illustrates a block diagram of a data plane in an LTE (4G) for packet processing according to an embodiment of the disclosure. FIG. 2 illustrates a tabular representation of a sample header structure in LTE (4G) for an RLC layer according to an embodiment of the disclosure. FIG. 3 illustrates a block diagram of a data plane in a NR (5G) for packet processing according to an embodiment of the disclosure. For the sake of brevity, FIGS. 1, 2, and 3 have been explained together.

Referring to FIGS. 1, 2, and 3, when the RLC receives grants (or transmission opportunity) from a lower layer, a transmitter entity concatenates a plurality of PDCP protocol data units (PDUs) or the PDCP packets into an RLC PDU and assigns an RLC sequence number (SN) for each of the RLC PDU as shown in the FIG. 1. In the LTE (4G), at least one of the RLC SN is assigned when the grants are available from the MAC 102 and at least one RLC SN maps to a plurality of PDCP PDUs because of a concatenation of the PDCP PDUs. Hence, the number of RLC SN required is fewer even for a plurality of the PDCP PDU packets, when the total size of the PDCP PDUs is smaller than or equal to the available grants. However, the RLC PDU is prepared only after receiving the grant as no part of the RLC is possible to be pre-processed. If the RLC PDU(s) are lost for the first time because of a block error rate (BLER), a status report is generated, which only needs to report the completely missed RLC SN. Further, when a not acknowledged (NACKed) RLC SN, which is a missing RLC SN whose acknowledgement from the receiver is not received, is retransmitted in case of fewer grants available, an acknowledged mode data (AMD) PDU segment is sent which is indicated using a re-segmentation flag (RF) in a header. Thus, an advantageous factor in the LTE (4G) RLC header 106 is the requirement of a lesser number of the RLC SN than the PDCP SN. However, the RLC header 106 in the LTE gives rise to various issues, for example, but are not limited to,
1. Multiple types of the header lead to variable sizes of the RLC header 106.
2. The number of the PDCP PDUs to be packed cannot be known before a complete RLC header 106 can be prepared only after receiving the grants. Hence, a length indicator (LI) 202 field in the RLC header 106 structure can be updated only after the grant.
3. In case of the re-segmentation in case of the retransmission of the NACKed RLC SN, the RLC header 106 needs to be updated to include the RF, a last segment flag (LSF), and a segment offset (SO) field and re-fill the LI 202 information based on the number of the PDCP PDUs getting concatenated during the re-segmentation as illustrated in FIG. 2.
4. The length of the last PDCP PDU included in the concatenated RLC PDU has to be computed by subtracting the RLC PDU LI 202 fields for the other PDCP PDUs from the total MAC PDU Length.

Thus, it can be gathered that LTE (4G) RLC header 106 yields the aforementioned problems by having a variable size RLC header 106 and no pre-processing of the RLC.

Further, the main functionalities of the RLC for the NR (5G) are the error correction mechanism through the ARQ, the in-order delivery mechanism, the segmentation and reassembly mechanism, the reordering mechanism, and so on. Thus, the RLC for the NR (5G) lacks a concatenation mechanism. The actual concatenation of packets happens in the MAC 102 based on the grant received for a Transport Block (TB) transmission. Thus, without the concatenation mechanism, the single RLC SN maps to the single RLC SDU, i.e., only one of the PDCP PDU, and hence, this is extremely advantageous in terms of the pre-processing as it is independent of grant reception 108.

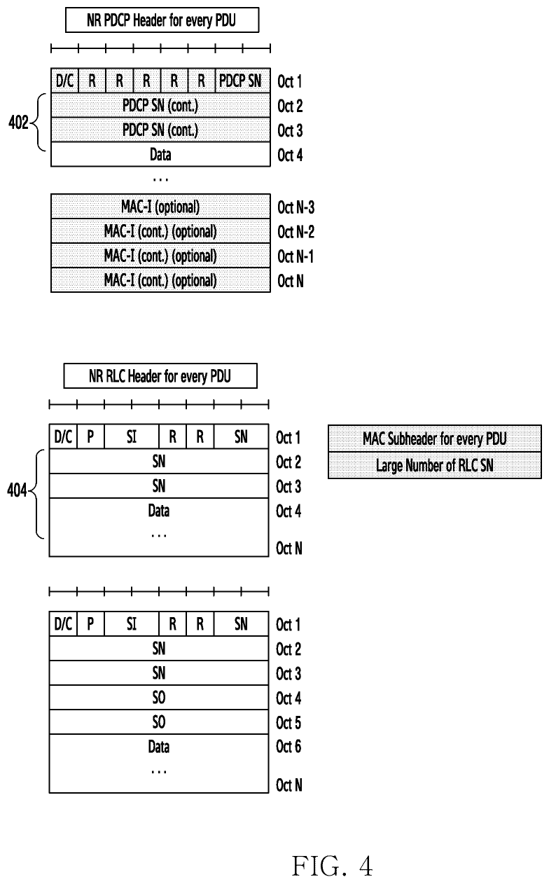

FIG. 4 illustrates a tabular representation of a sample header structure 400 in NR (5G) for an RLC layer according to an embodiment of the disclosure.

Referring to FIG. 4, a segmentation info field as illustrated indicates whether the RLC PDU contains the complete RLC SDU or the first, middle, and last segment of the RLC SDU. The SO indicates the segmentation offset field. The SO field indicates the position of the RLC SDU segment in bytes within the original RLC SDU. In the case of segmentation, and no grants, for the first segment, the segmentation information (SI) field is enough to indicate the first segment as SO=0 is redundant.

The advantages of the NR (5G) RLC header 106 can be listed as:
1. The NR (5G) RLC header 106 is of a fixed size.
2. The single RLC SN 404 is assigned to the single PDCP PDU.
3. RLC header 106 can be prepared even before a grant update operation.
4. The segmentation information can be easily filled without many changes to the already pre-processed RLC to complete the PDU header as only the SI bit needs to be updated for the first segment to be transferred.
5. During the segmentation or the re-segmentation, the RLC has just to prepare an RLC segment header 302 with the SO field.

Thus, it can be gathered that the NR (5G) RLC header 106 provides at least the fixed size RLC header 106, the pre-processed RLC, and efficient segment information.

Alternatively, the NR (5G) RLC header 106 yields various issues, such as:
1. In the NR (5G) RLC mechanism, a large number of the RLC SN 404 are required for window maintenance as the single RLC SN 404 gets mapped to the single PDCP SN 402. Further, the processing cycle at the receiver end increases due to extra sequence numbers.
2. For every grant, the MAC 102 has to prepare multiple MAC sub-header 104, as the MAC sub-header 104 captures the length of the RLC PDU information.
3. The length of each of the plurality of the RLC PDU or the RLC PDU segment is packed with the MAC sub-header 104.

Further, with the advent of a further increase in data demand, high bandwidth, and processing capability, it is viable that a future communication protocol system, particularly in systems beyond 5G/6G, would have a huge requirement for high-speed data processing. Applications like high definition (HD) video streaming, augmented reality (AR) or virtual reality (VR), holography, and digital twin require dedicated processing and stringent key performance index (KPI) requirements related to high throughput, low latency, and a zero jitter all met simultaneously. In such highly interactive immersive applications, there is fundamentally no practical difference between a lost packet and a late packet because of the synchronization required for multiple streams of the aforementioned applications. All the legacy protocol stack designs are focused on a no-loss data delivery making them unsuitable for such highly interactive immersive applications. Further, the legacy protocols have a layered processing which involves significant processing at each of the plurality of layers. At adjacent layers like the PDCP and the RLC, there exist duplicate functionalities like windowing, reordering, status report, and the like making a few functionalities redundant in some scenarios. Thus, it is required to simplify processing by removing the aforementioned redundancies across the complete protocol stack.

In addition, with an increased number of data packets to be processed in a short transmission time interval (TTI), there is a need to improve the data plane processing capability in various aspects in order to achieve extremely fast processing.

Recently, there have been many approaches to improving multi-core architecture designs. However, the current state-of-the-art techniques need to be simplified and fasten overhead of processing functionalities for the future generation protocol by providing a reliable communication mechanism for the application and the transport layers as well. Further, the current functionality of recovery at the RLC layer is typically to overcome a portion of residual loss from the MAC layer. The MAC 102 also has a hybrid automatic repeat request (HARQ) procedure to attempt recovery at the subsequent retransmissions. The higher protocol layers in the 4G or the 5G focus on no loss in-order packet delivery to overcome the residual MAC PDU loss, but at the cost of processing for the recovery and subsequent round-trip delays added for the recoveries. Hence, simplifying the procedure is necessary to achieve the next-generation application performance without complicating the existing procedures and techniques.

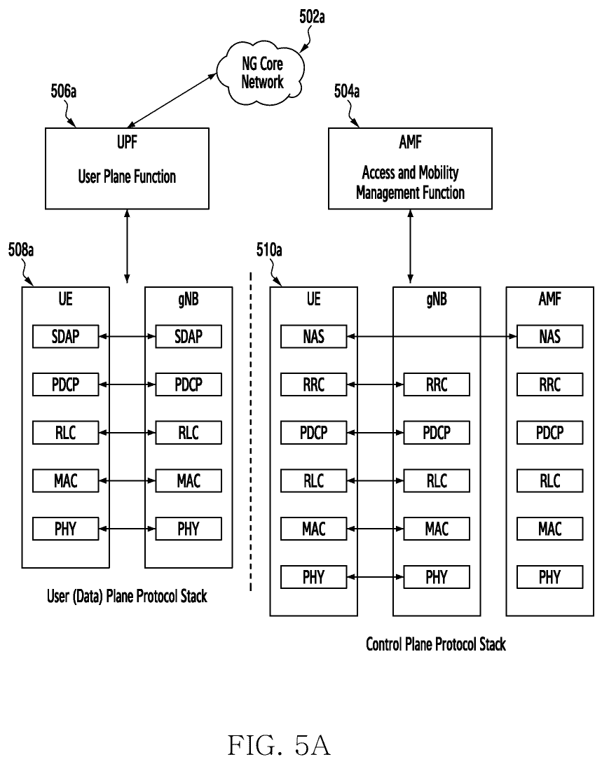

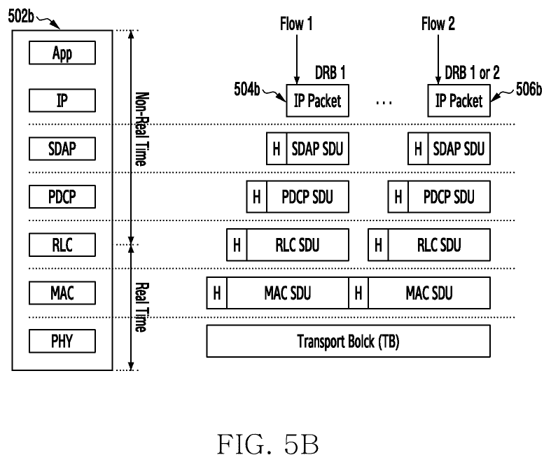

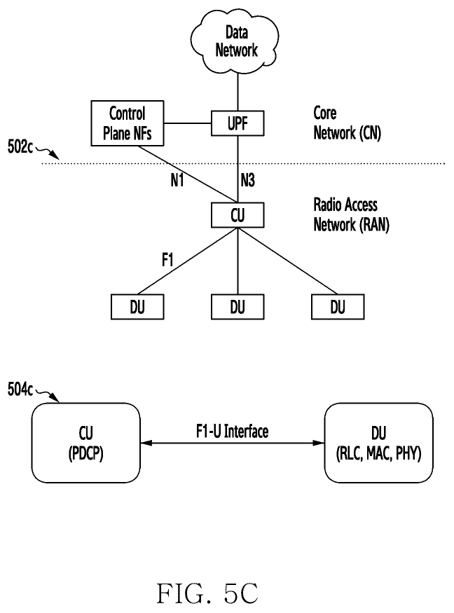

FIG. 5A illustrates a schematic diagram associated with 5G radio access network (RAN) protocol stack for user plane and control plane according to an embodiment of the disclosure.

Referring to FIG. 5A, it illustrates the protocol stack between user equipment (UE) and gNodeB (gNB) for user plane at 508a and for control plane at 510a. The user plane in the 5G RAN manages user data coming from the NG core network (CN) 502a. The data is accessed by the UE from the data network or the internet. The control plane stack 510a manages the signaling required to be exchanged between the NG CN 502a and UE or gNB at 510a. User plane function (UPF) 506a in the NR 5G supports features and capabilities to facilitate user plane functions, such as packet routing and forwarding, interconnection to the data network, policy enforcement and data buffering.

Further, Layer 2 of the open system interconnections (OSI) model or data link layer at user plane stack 508a comprises layers like PDCP, RLC, and MAC. The service data adaption protocol (SDAP) layer is added for 5G NR and primarily serves quality of service (QoS) to resource block (RB) mapping and is an optional layer. The access and mobility management function (AMF) 504a terminates the control plane of different access networks onto the NG CN 502a. AMF 504a may interact directly with the UE via non-access stratum (NAS) signaling as illustrated at 510a. The primary functions of the AMF 504a may include registration management, connection management, reachability management, mobility management, and functions related to security, access management, and authorization.

FIG. 5B illustrates a schematic diagram associated with a layered processing of data packets in an NR network according to an embodiment of the disclosure.

Referring to FIG. 5B, in a 5G NR network data packets from different applications may be mapped to the same data radio bearer (DRB) or different DRBs. Each layer receives a service data unit (SDU) and attaches a header to generate a protocol data unit (PDU) for the network layer. For example, the PDCP layer receives a plurality of SDUs and attaches a PDCP header to the received plurality of SDUs to generate a PDCP PDU.

Further, the MAC layer in the 5G NR is configured to concatenate multiple data packets and transfer the packets through the NR network in the form of transport blocks based on the grants (amount of data that can be transmitted in a transmission interval over the network). The RLC network layer is configured to perform segmentation based on the grant. A major problem with the protocol hierarchy in 5G NR is associated with significant processing and latency at each layer. Each network layer involves significant processing in terms of header processing.

FIG. 5B further illustrates that the functions associated with network layers above the RLC network layer, such as PDCP are not performed in real-time. The segmentation handling at RLC and the grant handling at the MAC network layer are performed in real-time. The remaining processing at the network layers illustrated in the protocol stack is usually performed in non-real-time.

FIG. 5C illustrates a schematic diagram associated with NR network architecture and interfaces according to an embodiment of the disclosure.

Referring to FIG. 5C, the 5G NR telecommunication network usually consists of a data network, control plane network functions and user plane functions and is termed the core network (CN). The radio access network (RAN) may be further split into multiple entities as per the split options provided in the technical standards, such as 3GPP standards. The figure at 502c illustrates one of the most commonly used split options (Option 2), wherein gNB (Base Station) is split into two entities viz. gNB-centralized unit (CU) and gNB-distributed unit (DU). In the option, CU consists of PDCP whereas DU contains RLC and MAC network layers. The PDCP layer is primarily responsible for functions, such as data transfer security compression and anchor point for handover. While the RLC layer is responsible for functions, such as data transfer, segmentation & reassembly, and recovery.

Further, at 504c the figure illustrates the CU-DU split, which may include the PDCP network layer and DU may include the RLC, MAC, and physical network layers. At 504c, the F1-U interface connects the CU and DU of the RAN.

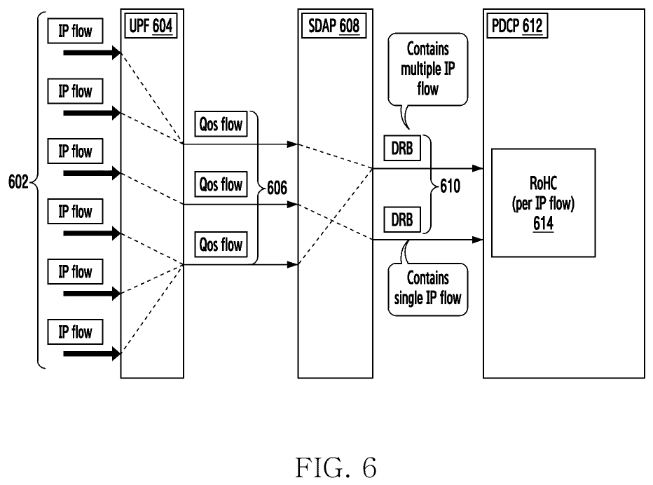

FIG. 6 illustrates a flowchart of placeholder functionality 600 of a robust header compression (ROHC) processing performed on a data radio bearer (DRB) at PDCP layer according to an embodiment of the disclosure.

Referring to FIG. 6, the functionality for the header compression is being performed at a PDCP layer 612. In the current state of the art in FIG. 6, an Internet protocol (IP) flow 602 is received at a user plane function (UPF) 604, which is then mapped to a quality of service (QoS) flow 606 based on the rules configured at the UPF 604 for packet handling. A service data adaptation protocol (SDAP) layer 608 is present at a control unit (CU), then maps the QoS 606 to a radio bearer (RB) and the PDCP 612 operates on the a 610 packets directly. When a header compression is configured, it performs the header compression as per the standard algorithms on the IP packet. The PDCP 612 has to maintain the IP information to perform the header compression appropriately for flows for which the header compression is configured. In an example, the header compression functionality can be performed much above in the hierarchy at the entry point of the IP flow 602 from the data network at the UPF 604 directly. In another embodiment of the disclosure, it is possible that the UPF 604 performs a ROHC 614 algorithm on the required IP flow 602 and then maps the compressed IP flow 602 to the QoS flow 606. These techniques are associated with redundant intermixing of IP flows at the SDAP layer 608.

To achieve the aforementioned requirements, a communication protocol requires to be optimized to provide at least, for example, a highly efficient way of packing information, minimal overhead in terms of processing, light functionalities, scalable solutions, and a reliable mechanism for service to upper layers.

Thus, there is a need to define a simplified protocol with reduced redundancy and optimized functionality, in order to meet the strict processing requirements to meet throughput and the latency KPIs and provide reliable and jitter-free communication.

It should be understood at the outset that although illustrative implementations of the embodiments of the disclosure are illustrated below, the disclosure may be implemented using any number of techniques, whether currently known or in existence. The disclosure should in no way be limited to the illustrative implementations, drawings, and techniques illustrated below, including the design and implementation illustrated and described herein, but may be modified within the scope of the appended claims along with their full scope of equivalents.

The term “some” as used herein is defined as “none, or one, or more than one, or all.” Accordingly, the terms “none,” “one,” “more than one,” “more than one, but not all” or “all” would all fall under the definition of “some.” The term “some embodiments” may refer to no embodiments of the disclosure, to one embodiment or to several embodiments or to all embodiments. Accordingly, the term “some embodiments” is defined as meaning “no embodiment, or one embodiment, or more than one embodiment, or all embodiments.”

The terminology and structure employed herein is for describing, teaching, and illuminating some embodiments and their specific features and elements and does not limit, restrict, or reduce the spirit and scope of the claims or their equivalents.

More specifically, any terms used herein, such as but not limited to “includes,” “comprises,” “has,” “consists,” and grammatical variants thereof do NOT specify an exact limitation or restriction and certainly do NOT exclude the possible addition of one or more features or elements, unless otherwise stated, and furthermore must NOT be taken to exclude the possible removal of one or more of the listed features and elements, unless otherwise stated with the limiting language “MUST comprise” or “NEEDS TO include.”

Whether or not a certain feature or element was limited to being used only once, either way, it may still be referred to as “one or more features” or “one or more elements” or “at least one feature” or “at least one element.” Furthermore, the use of the terms “one or more” or “at least one” feature or element does NOT preclude there being none of that feature or element, unless otherwise specified by limiting language, such as “there NEEDS to be one or more . . . ” or “one or more element is REQUIRED.”

Unless otherwise defined, all terms, and especially any technical and/or scientific terms, used herein may be taken to have the same meaning as commonly understood by one having ordinary skill in the art.

Embodiments of the disclosure will be described below with reference to the accompanying drawings.

According to an embodiment of the disclosure, the disclosure discloses a method and a system for optimizing the network protocol layer functionality of a network. The network herein may include a 5G network or a 6G network, to optimize the functionality of the network layers. The optimized functionality of the network layer is associated with reduced redundancy in the functionality of the network layers and enhanced throughput and performance of the network.

As used herein, the PDCP PDU is at least one of a status PDCP PDU, a retransmission PDCP PDU, and a data PDCP PDU.

The term “module” used in the document may imply a unit including, for example, one of hardware, software, and firmware or a combination of two or more of them. The “module” may be interchangeably used with a term, such as a unit, a logic, a logical block, a component, a circuit, and the like. The “module” may be a minimum unit of an integrally constituted component or may be a part thereof. The “module” may be a minimum unit for performing one or more functions or may be a part thereof. The “module” may be mechanically or electrically implemented. For example, the “module” of the disclosure may include at least one of an application-specific integrated circuit (ASIC) chip, a field-programmable gate array (FPGAs), and a programmable-logic device, which are known or will be developed, and which perform certain operations.

As is traditional in the field, embodiments may be described and illustrated in terms of modules that carry out a described function or functions. These modules, which may be referred to herein as units or blocks or the like, or may include blocks or units, are physically implemented by analog or digital circuits, such as logic gates, integrated circuits, microprocessors, microcontrollers, memory circuits, passive electronic components, active electronic components, optical components, hardwired circuits, or the like, and may optionally be driven by firmware and software. The circuits may, for example, be embodied in one or more semiconductor chips, or on substrate supports, such as printed circuit boards and the like. The circuits constituting a block may be implemented by dedicated hardware, by a processor (e.g., one or more programmed microprocessors and associated circuitry), or by a combination of dedicated hardware to perform some functions of the block and a processor to perform other functions of the block. Each block of the embodiments may be physically separated into two or more interacting and discrete blocks without departing from the scope of the disclosure. Likewise, the blocks of the embodiments may be physically combined into more complex blocks without departing from the scope of the disclosure.

The methodology of the disclosure is explained in the following paragraphs.

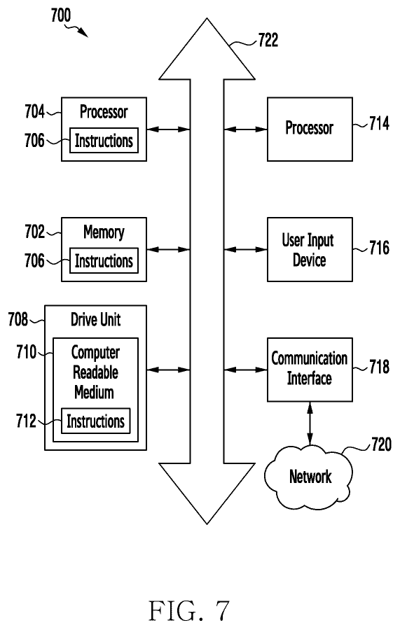

FIG. 7 illustrates a system architecture in a form of a computer system, according to an embodiment of the disclosure.

Referring to FIG. 7, a system 700 may include memory 702 and a processor 704 communicatively coupled to the memory 702. System 700 may include one or more processors or at least one processor. The processor 704 may be implemented as one or more microprocessors, microcomputers, microcontrollers, digital signal processors, central processing units, state machines, logic circuitries, and/or any devices that manipulate signals based on operational instructions. Among other capabilities, the processor 704 may be configured to fetch and execute computer-readable instructions and data stored in the memory 702. At this time, the processor 704 may be a general-purpose processor, such as a central processing unit (CPU), an application processor (AP), or the like, and an AI-dedicated processor, such as a neural processing unit (NPU). The processor 704 may control the processing of input data in accordance with a predefined operating rule or artificial intelligence (AI) model stored in the non-volatile memory and the volatile memory, i.e., the memory 702. The predefined operating rule or artificial intelligence model is provided through training or learning. Further, the processor 704 may be operatively coupled to each of the memory, the input output (I/O) Interface. The processor 704 may be configured to process, execute, or perform a plurality of operations described herein.

The memory 702 may include any non-transitory computer-readable medium known in the art including, for example, volatile memory, such as static random-access memory (SRAM) and dynamic random-access memory (DRAM), and/or non-volatile memory, such as read-only memory (ROM), erasable programmable ROM, flash memories, hard disks, optical disks, and magnetic tapes. The memory 702 is communicatively coupled with the processor 704 to store processing instructions 706 for completing the process. Further, the memory 702 may include an operating system for performing one or more tasks of the system, as performed by a generic operating system in a computing domain. The memory 702 is operable to store instructions executable by the processor 704.

In some embodiments of the disclosure, the system 700 may include a set of instructions 706 that can be executed to cause the system 700 to perform any one or more of the methods disclosed. The system 700 may operate as a standalone device or may be connected, e.g., using a network, to other computer systems or peripheral devices.

In a networked deployment, the system 700 may operate in the capacity of a server or as a client user computer in a server-client user network environment, or as a peer system in a peer-to-peer (or distributed) network environment. The system 700 can also be implemented as or incorporated across various devices, such as a personal computer (PC), a tablet PC, a personal digital assistant (PDA), a mobile device, a palmtop computer, a laptop computer, a desktop computer, a communications device, a wireless telephone, a land-line telephone, a web appliance, a network router, switch or bridge, or any other machine capable of executing a set of instructions (sequential or otherwise) that specify actions to be taken by that machine. Further, while a single system 700 is illustrated, the term “system” shall also be taken to include any collection of systems or sub-systems that individually or jointly execute a set, or multiple sets, of instructions to perform one or more computer functions.

As discussed, the system 700 may include the processor 704 e.g., a central processing unit (CPU), a graphics processing unit (GPU), or both. The processor 704 may be a component in a variety of systems. For example, the processor 704 may be part of a standard personal computer or a workstation. The processor 704 may be one or more general processors, digital signal processors, application-specific integrated circuits, field-programmable gate arrays, servers, networks, digital circuits, analog circuits, combinations thereof, or other now-known or later developed devices for analyzing and processing data. The processor 704 may implement a software program, such as code generated manually (i.e., programmed).

As mentioned above, the system 700 may include the memory 702, such as memory 702 that can communicate via a bus 722. The memory 702 may include but is not limited to computer-readable storage media, such as various types of volatile and non-volatile storage media, including but not limited to random access memory, read-only memory, programmable read-only memory, electrically programmable read-only memory, electrically erasable read-only memory, flash memory, magnetic tape or disk, optical media and the like. In one example, memory 702 includes a cache or random-access memory for the processor 704. In alternative examples, the memory 702 is separate from the processor 704, such as cache memory of a processor, the system memory, or other memory. The memory 702 may be an external storage device or database for storing data. The memory 702 is operable to store instructions 706 executable by the processor 704. The functions, acts or tasks illustrated in the figures or described may be performed by the programmed processor 704 for executing the instructions 706 stored in the memory 702. The functions, acts or tasks are independent of the particular type of instructions set, storage media, processor or processing strategy and may be performed by software, hardware, integrated circuits, firmware, micro-code and the like, operating alone or in combination. Likewise, processing strategies may include multiprocessing, multitasking, parallel processing and the like.

As shown, the system 700 may or may not further include a display unit 714, such as a liquid crystal display (LCD), an organic light-emitting diode (OLED), a flat panel display, a solid-state display, a cathode ray tube (CRT), a projector, a printer or other now known or later developed display device for outputting determined information. The display 714 may act as an interface for the user to see the functioning of the processor 704, or specifically as an interface with the software stored in the memory 702 or a drive unit 708.

Additionally, the system 700 may include an input device 716 configured to allow the user to interact with any of the components of system 700. The system 700 may also include the drive unit 708. The drive unit 708 may include a computer-readable medium 710 in which one or more sets of instructions 712, e.g., software, can be embedded. Further, the instructions 712 may embody one or more of the methods or logic as described. In a particular example, the instructions 712 may reside completely, or at least partially, within the memory 702 or within the processor 704 during execution by the system 700.

The disclosure contemplates a computer-readable medium that includes instructions 712 or receives and executes instructions 712 responsive to a propagated signal so that a device connected to a network 720 can communicate voice, video, audio, images, or any other data over the network 720. Further, the instructions 712 may be transmitted or received over network 720 via a communication port or interface 718 or using bus 722. The communication port or interface 718 may be a part of the processor 704 or maybe a separate component. The communication interface 718 may be created in software or maybe a physical connection in hardware. The communication interface 718 may be configured to connect with a network 720, external media, the display 714, or any other components in system 700, or combinations thereof. The connection with the network 720 may be a physical connection, such as a wired Ethernet connection or may be established wirelessly as discussed later. Likewise, the additional connections with other components of the system 700 may be physical or may be established wirelessly. The network 720 may alternatively be directly connected to the bus 722.

The network 720 may include wired networks, wireless networks, ethernet audio video bridging (AVB) networks, or combinations thereof. The wireless network may be a cellular telephone network, an 802.11, 802.16, 802.20, 802.1Q or worldwide interoperability of microwave access (WiMAX) network. Further, the network 720 may be a public network, such as the Internet, a private network, such as an intranet, or combinations thereof, and may utilize a variety of networking protocols now available or later developed including, but not limited to transmission control protocol/Internet protocol (TCP/IP) based networking protocols. The system 700 may not be limited to operation with any particular standards and protocols. For example, standards for Internet and other packet-switched network transmissions (e.g., TCP/IP, user datagram protocol (UDP) over Internet protocol (UDP/IP), hypertext markup language (HTML), and hypertext transfer protocol (HTTP)) may be used.

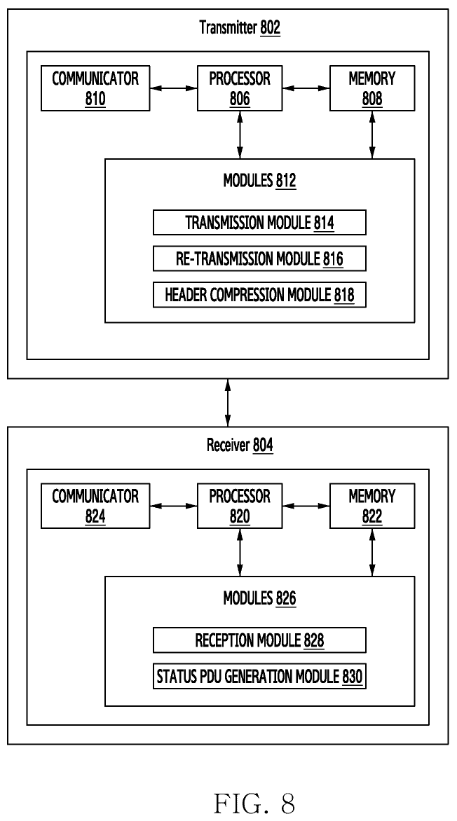

FIG. 8 is a block diagram associated with a transmitter and receiver in a network according to an embodiment of the disclosure.

Referring to FIG. 8, a transmitter 802 and a receiver 804 are illustrated. The transmitter 802 and receiver 804 are part of the system 700 and are configured to implement the method and embodiments of the disclosure. The transmitter 802 and receiver 804 may correspond to one or more entities interacting over the network using data plane (or user plane) protocol stack 508a. The same device or entity in the network may serve as transmitter and receiver for two-way communication between entities using a data plane stack for communication over the network. The components of the transmitter and receiver, such as processor, memory, and communicator may correspond to the same component on a device based on the device acting as transmitter or receiver for two-way communication in the network.

The transmitter 802 may include a communicator 810, processor 806, and memory 808 coupled to each other and with modules 812 to perform one or more instructions or steps to implement the disclosure. In an example, the transmitter 802 may correspond to the base station, the laptop computer, the desktop computer, the personal computer (PC), the notebook, the smartphone, the tablet, the smartwatch, the smart television, the IoT devices, and the like. The embodiments of processor 806 may correspond to one or more embodiments that may be used to implement processor 704. Similarly, communicator 810 may correspond to one or more embodiments that may be used to implement communication interface 718, and memory 808 may correspond to one or more embodiments that may be used to implement memory 702. The details are not repeated herein for the sake of brevity and clarity. Further, the modules 812 may include transmission module 814, re-transmission module 816, and header compression module 818. The module(s) 812 when executed by the processor(s) 806 may be configured to perform any of the described functionalities provided for respective modules in the forthcoming paragraphs.

The receiver 804 may include a communicator 824, processor 820, and memory 822 coupled to each other and with modules 826 to perform one or more instructions or steps to implement the disclosure. The embodiments of processor 820 may correspond to one or more embodiments that may be used to implement processor 704. Similarly, communicator 824 may correspond to one or more embodiments that may be used to implement communication interface 718, and memory 822 may correspond to one or more embodiments that may be used to implement memory 702. The details are not repeated herein for the sake of brevity and clarity. Further, module 826 may include reception module 828, and status PDU generation module 830. The module(s) 826 when executed by the processor(s) 820 may be configured to perform any of the described functionalities provided for respective modules in the forthcoming paragraphs.

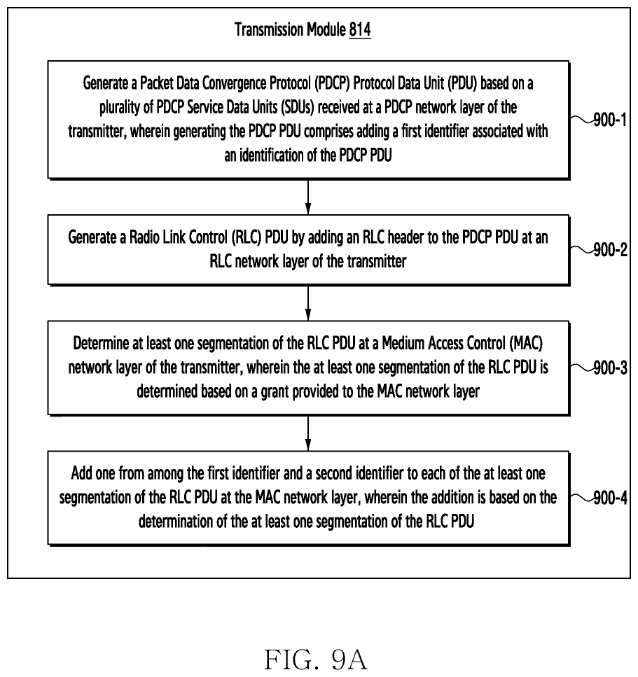

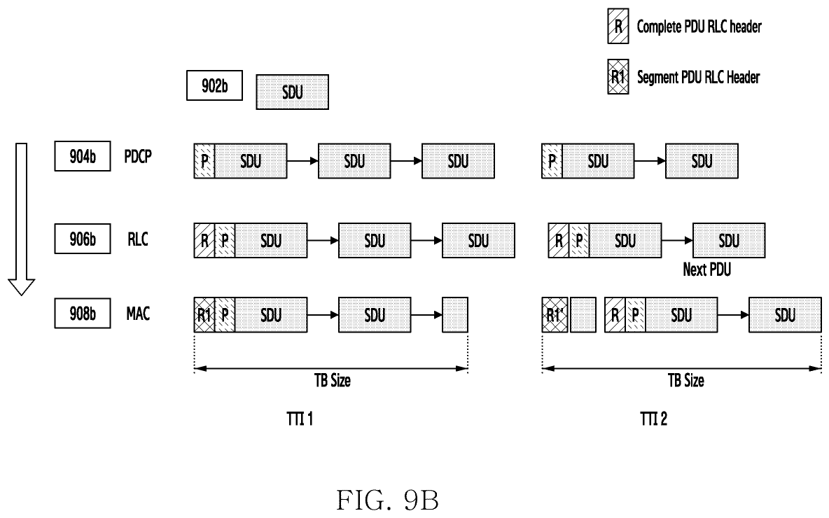

FIG. 9A illustrates a process flow associated with transmission module for a generation of PDU for a data plane processing at a transmitter according to an embodiment of the disclosure.

Referring to FIG. 9A, at operation 900-1, the transmission module 814 may be configured to generate a packet data convergence protocol (PDCP) protocol data unit (PDU) based on a plurality of PDCP service data units (SDUs) received at PDCP network layer of the transmitter, wherein generating the PDCP PDU comprises adding a first identifier associated with identification of the PDCP PDU.

In an embodiment of the disclosure, the transmission module 814 is configured to generate PDCP PDU and add a PDCP header. The PDCP header includes a PDCP sequence number (SN) and the PDCP SN corresponds to the first identifier.

At operation 900-2, the transmission module 814 may be configured to generate a radio link control (RLC) PDU by adding an RLC header to the PDCP PDU at RLC network layer of the transmitter.

In the embodiment of the disclosure, the RLC network layer adds an RLC header to the PDCP PDU, where the PDCP PDU becomes an SDU for the RLC network layer. The RLC header is configured for the absence of segmentation information (SI) and segmentation offset (SO) which results in a reduction in the size of the RLC header.

At operation 900-3, the transmission module 814 may be configured to determine at least one segmentation of the RLC PDU at the medium access control (MAC) network layer of the transmitter, wherein the at least one segmentation of the RLC PDU is determined based on a grant provided to the MAC network layer.

In the embodiment of the disclosure, the MAC network layer receives the RLC PDU and determines the requirement of segmentation of the RLC PDU based on the transmission time interval (TTI) or grant. In case the segmentation is performed on the RLC PDU, the MAC network layer adds RLC SN.

At operation 900-4, the transmission module 814 may be configured to add one from among the first identifier and a second identifier to each of the at least one segmentation of the RLC PDU at the MAC network layer, wherein the addition is based on the determination of the at least one segmentation of the RLC PDU.

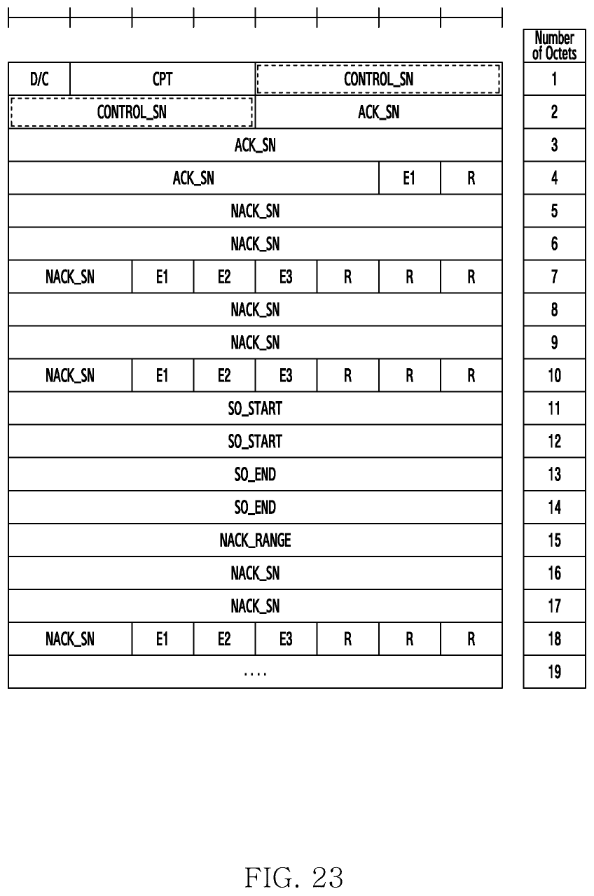

In the embodiment of the disclosure, the MAC network layer adds either the first identifier or a second identifier as RLC SN. The addition of RLC SN to the PDU, where the RLC SN is the same as the first identifier or PDCP SN is described as an embodiment of the disclosure in the description of FIGS. 23, 24, 25, 26, 27, and 28.

In case a second identifier is assigned as RLC SN by the transmission module 814 at the MAC network layer, the RLC SN and PDCP SN are different. FIGS. 9 to 22 describe the implementation of the disclosure for the second identifier assigned as RLC SN and the description is to be read together to understand the disclosure. FIG. 9A represents the associated schematic diagram of the process flow provided in FIG. 9B.

FIG. 9B illustrates a schematic diagram associated with a generation of PDU for a data plane processing at a transmitter according to an embodiment of the disclosure.

Referring to FIG. 9B, the PDCP network layer prepares the PDCP PDU after receiving PDCP SDUs at 904a. The PDCP header “P” is added to the PDCP SDUs. The PDCP header contains the first identifier or PDCP SN. The PDCP network layer is configured to receive SDUs 902a and receive the total PDCP PDU. Further, the PDCP PDU contains one or more SDU 902a and PDCP PDU contains complete SDUs. Further, in the embodiment of the disclosure, the PDCP network layer may perform compression and security operation on per SDU or per PDU based on configuration and the PDCP Header may be part of integrity protection.

At 906a, the RLC network layer adds an RLC header “R”, where the RLC header does not include SN and SO. In the case of segmentation of RLC PDU, as shown at 908a, an RLC SN is assigned to RLC PDU. The RLC SN may be the same as the PDCP SN (first identifier) or a new RLC SN may be assigned as RLC SN. FIG. 9A illustrates a scenario where a new RLC SN is assigned differently from the PDCP SN. At 908a, “R1” corresponds to the RLC header when segmentation is performed on the RLC PDU based on the grant or TTI. The RLC header R1 contains a new RLC SN different from the PDCP SN. Furthermore, data packet concatenation is performed at the PDCP network layer for implementation of the disclosure.

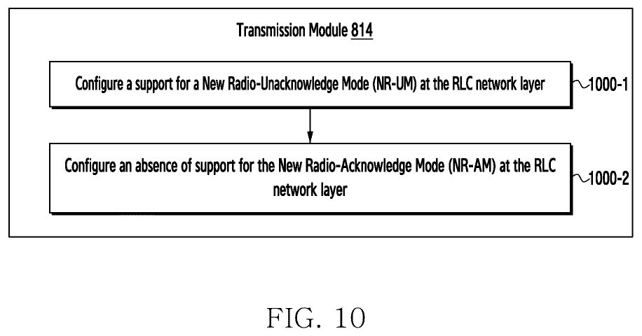

FIG. 10 illustrates a process flow associated with transmission module to configure modes for a RLC network layer at a transmitter according to an embodiment of the disclosure.

Referring to FIG. 10, at operation 1000-1, the transmission module 814 may be configured to configure support for a new radio-unacknowledge mode (NR-UM) at the RLC network layer.

At operation 1000-2, the transmission module 814 may be configured to configure the absence of support for the new radio-acknowledge mode (NR-AM) at the RLC network layer.

In an embodiment of the disclosure, the RLC network layer at the transmitter is configured to support 5G NR unacknowledge mode (UM) and a mode similar to 5G NR UM. As per the 5G NR UM, the packet recovery does not take place at the RLC network layer. In addition, the RLC network layer adds SN only for the packets that are being segmented due to lower layer packing in the data in the available grant or transmission opportunity.

Thus, the proposed RLC network layer as per the disclosure functions similar to the 5G NR UM. In the embodiment of the disclosure, the RLC SN is assigned only for those packets that are segmented. Further, the recovery procedure is not performed at the RLC network layer. Furthermore, support for 5G NR acknowledge mode (AM) is disabled at the RLC network layer in the embodiment. A similar configuration for operation mode may be configured at the RLC network layer at the receiver.

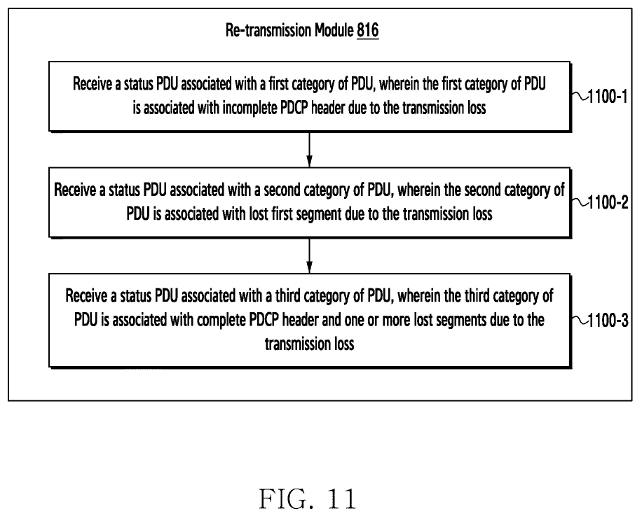

FIG. 11 illustrates a process flow associated with a re-transmission module for receiving status PDU to determine data packets to be retransmitted according to an embodiment of the disclosure.

Referring to FIG. 11, at operation 1100-1, the re-transmission module 816 may be configured to receive a status PDU associated with a first category of PDU, wherein the first category of PDU is associated with an incomplete PDCP header due to transmission loss.

In an embodiment of the disclosure, the data packets transmitted from the transmitter 802 may be lost in the network. In such a scenario, the transmitter 802 is required to retransmit the lost data packets or lost segments of the data packets. The retransmission is performed based on receiving status PDU, where the status PDU is generated at the receiver 804.

In the embodiment of the disclosure, the first category of PDU (or data packets) corresponds to PDUs with PDCP header lost or incomplete. The identification of the category of PDU based on the lost segment may be used to determine the segment of the data packets associated with transmission loss to be discarded at the receiver 804. Further, the category of PDU forms the basis for the retransmission of the lost segment of the PDU or retransmission of the complete PDU by the retransmission module 816.

At operation 1100-2, the re-transmission module 816 may be configured to receive a status PDU associated with a second category of PDU, wherein the second category of PDU is associated with the lost first segment due to the transmission loss.

In the embodiment of the disclosure, the second category of PDU (or data packets) corresponds to PDUs with the first segment lost during transmission. The loss of the first segment usually results in the loss of header for the network layers in the protocol stack, thereby making identification and reassembly of PDU at the receiver 804 difficult.

At operation 1100-3, the re-transmission module 816 may be configured to receive a status PDU associated with a third category of PDU, wherein the third category of PDU is associated with a complete PDCP header and one or more lost segments due to the transmission loss.

In the embodiment of the disclosure, the third category of PDU is associated with the complete PDCP header received in the first segment. The transmission loss is limited to a middle segment of the PDU or the last segment of the PDU.

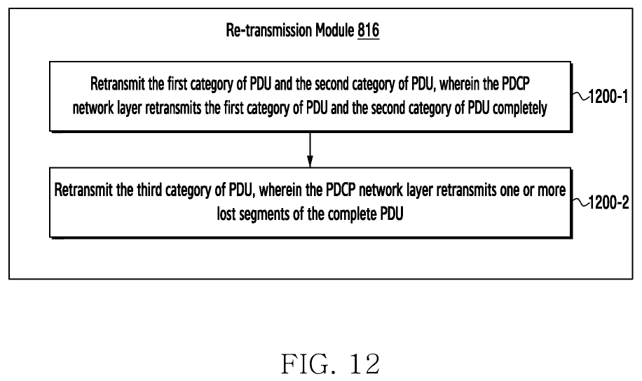

The description of FIGS. 11 and 12 are associated with re-transmission based on the first, second and third categories of PDU to be retransmitted for a status PDU received at the transmitter 802.

FIG. 12 illustrates a process flow associated with a re-transmission module for retransmitting data packets at a transmitter according to an embodiment of the disclosure.

Referring to FIG. 12, at operation 1200-1, the re-transmission module 816 may be configured to retransmit the first category of PDU and the second category of PDU, wherein the PDCP network layer retransmits the first category of PDU and the second category of PDU completely.

In an embodiment of the disclosure, for the identified first category or second category of PDU, the re-transmission module 816 may be configured to retransmit the first category PDU and the second category PDU completely. Complete retransmission is required as the loss of the PDCP header, or loss of the first segment containing the header makes reassembly of the data packets or PDUs at the receiver difficult.

At operation 1200-2, the re-transmission module 816 may be configured to retransmit the third category of PDU, wherein the PDCP network layer retransmits one or more lost segments of the complete PDU.

In the embodiment of the disclosure, for identified third category of PDU or data packets, the lost segments are retransmitted. Further in the embodiment of the disclosure, a modification of the F1-U interface is performed at the transmitter 802. The F1-U interface is configured for prioritization of PDUs. The status PDU is assigned the highest priority, followed by the retransmission PDU and the data PDU is assigned the lowest priority. The retransmission is assigned a higher priority than handling the normal data PDU.

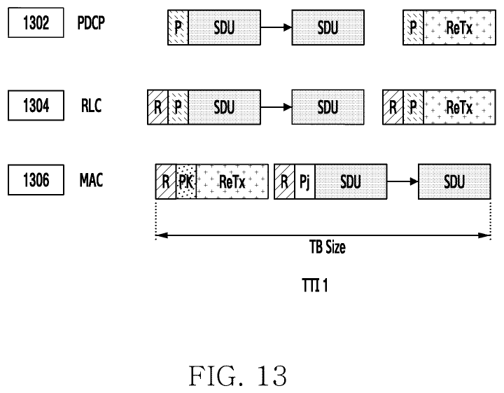

FIG. 13 illustrates a schematic diagram associated with retransmitting data packets at a transmitter according to an embodiment of the disclosure.

Referring to FIG. 13, at 1302, the retransmission of a PDU lost during transmission is illustrated. PDCP header “P” is added to the retransmission PDU (shown as ReTx). In the disclosure, the PDCP network layer is responsible for retransmissions instead of the RLC network layer. The PDCP network layer usually performs complete PDU retransmissions. In an exception, PDU segment retransmission may be performed for segment handling based on the t-reassembly timer of the RLC.

At 1304, an RLC header “R” is added to the data PDU and the retransmission PDU. At 1306, the priority of retransmission PDU is higher and is placed prior to the data PDU and retransmitted to the receiver 804. Further, information regarding presence of retransmission (ReTx) PDU is required to be conveyed over F1-U for prioritization of retransmission PDU.

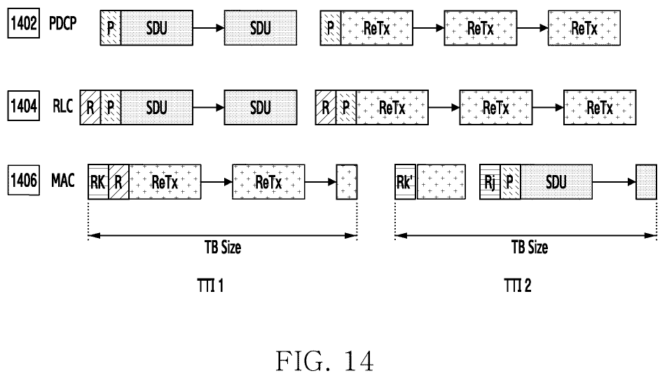

FIG. 14 illustrates a schematic diagram associated with reassembly of retransmitted data packets at a receiver according to an embodiment of the disclosure.

Referring to FIG. 14, at 1406, the retransmission PDU are received for reassembly at the receiver 804. The segments of the retransmission PDU are combined with a priority higher than the data PDU.

At 1404, the RLC network layer handles the retransmission PDU (ReTx) as normal data PDU (containing SDU) and delivers it to the PDCP network layer after RLC header “R” removal. At 1402, the PDCP network layer reassembles the PDUs as illustrated in the Figure.

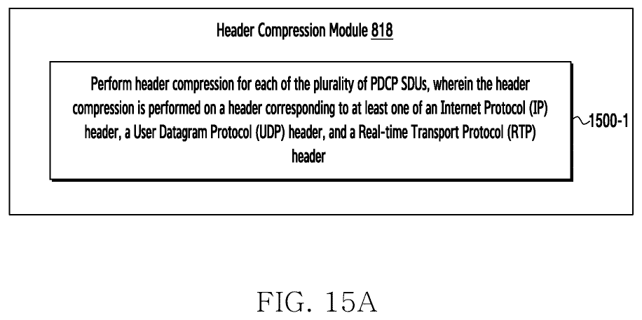

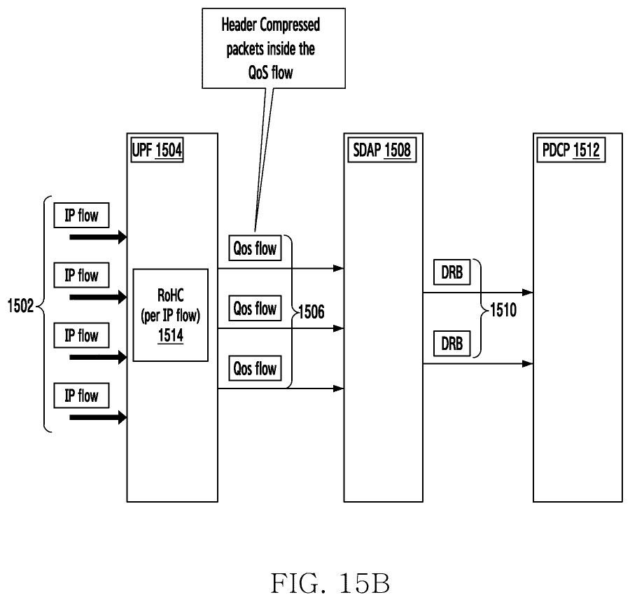

FIG. 15A illustrates a process flow diagram associated with a header compression at a PDCP network layer according to an embodiment of the disclosure.

Referring to FIG. 15A, at operation 1500-1, the header compression module may be configured to perform header compression for each of the plurality of PDCP SDUs, wherein the header compression is performed on a header corresponding to at least one of an Internet protocol (IP) header, a user datagram protocol (UDP) header, and a real-time transport protocol (RTP) header.

In an embodiment of the disclosure, the header compression may be performed on a per SDU basis for the IP/UDP/RTP header. The header field may be divided into static and dynamic components. The static component is sent initially as a one-time transmission. Thereafter, the dynamic component of the header is transmitted. The compression is set up per resource block (RB) basis at the PDCP network layer and is performed per IP flow basis using multiple contexts of robust header compression (ROHC) dedicated for individual IP flow.

Further, in the embodiment of the disclosure, a loss of any PDU due to decompression failure may be handled at PDCP using either PDCP Status PDU or by sending ROHC feedback. In the disclosure, the header decompression may be performed at PDCP on a per SDU basis. Furthermore, the ROHC may be performed either at the SDAP or the UPF.

FIG. 15B illustrates a block diagram of a sample header structure for an F1-U interface between a PDCP and an RLC layer according to an embodiment of the disclosure.

Referring to FIG. 15B, an IP flows 1502 are received at UPF 1504, which are then mapped to QoS flows 1506 based on the rules configured at UPF 1504 for packet handling. The SDAP layer 1508 is present at CU (not shown), then maps the QoS 1506 to RB, and PDCP 1512 operates on the DRB 1510 packets directly. When header compression is configured, it performs the header compression as per the standard algorithms defined in the specification on the IP packet. PDCP 1512 has to maintain the IP information to perform header compression appropriately for flows for which the header compression is configured. It is possible that as an option, the header compression functionality can be performed much above in the hierarchy at the entry point of IP flow 1502 from the data network at the UPF 1504 directly. In an embodiment of the disclosure, it is possible that the UPF 1504 performs robust header compression (ROHC) 1514 algorithms on the required IP flows 1502 and then maps the compressed IP flows 1502 to QoS flows 1506. One such example procedure is shown in FIG. 15. The IP flow 1502 information is kept intact at the UPF 1504 for performing ROHC 1514 operation.

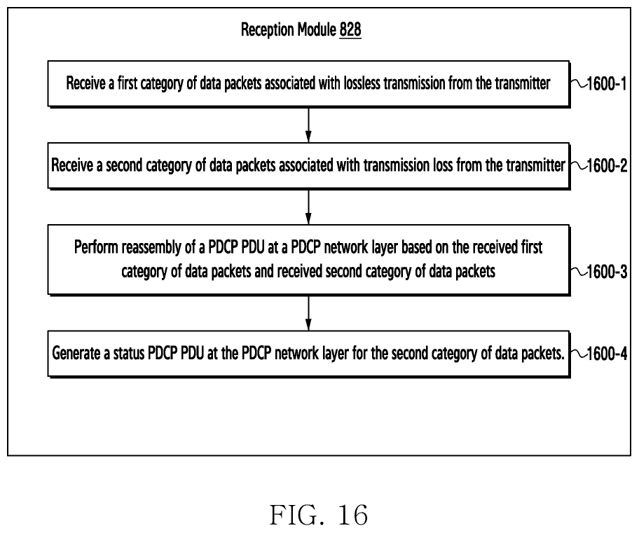

FIG. 16 illustrates a process flow diagram associated with a reception module to receive and rearrange data packets for a data plane processing at a receiver according to an embodiment of the disclosure.

Referring to FIG. 16, at operation 1600-1, the reception module 828 is configured to receive a first category of data packets associated with lossless transmission from the transmitter.

At operation 1600-2, the reception module is configured to receive a second category of data packets associated with transmission loss from the transmitter.

At operation 1600-3, the reception module is configured to perform the reassembly of a PDCP PDU at a PDCP network layer based on the received first category of data packets and the received second category of data packets.

At operation 1600-4, the reception module is configured to generate a status PDCP PDU at the PDCP network layer for the second category of data packets.

In an embodiment of the disclosure, the reception module 828 is configured to receive data packets for lossless transmission in the network. The reception module 828 is further configured to receive data packets with one or more segments during transmission. The PDCP network layer via the reception module 828 at the receiver 804 is configured to perform the reassembly of data packets or PDU for the first category or second category of data packets. Furthermore, the status PDU may be generated at the receiver 804 for the second category of data packets. The status PDU is used by the transmitter 802 to determine the data packets or segments of the data packets to be retransmitted. The reception and reassembly of the data packets at the receiver and status PDU generation in accordance with the disclosure are explained in the forthcoming paragraphs.

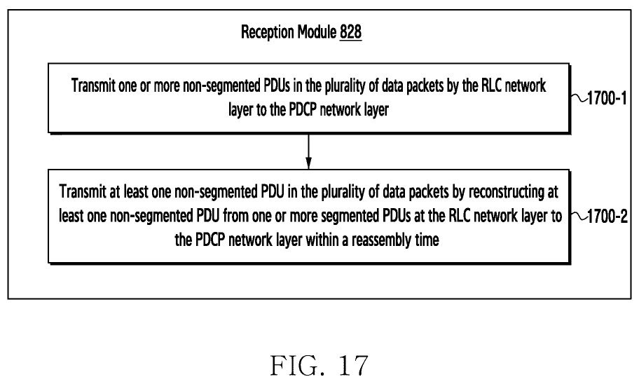

FIG. 17 illustrates a process flow diagram associated with a reception module to rearrange data packets at a receiver for no loss of data packets in a network according to an embodiment of the disclosure.

Referring to FIG. 17, at operation 1700-1, the reception module 828 is configured to transmit one or more non-segmented PDUs in the plurality of data packets by the RLC network layer to the PDCP network layer.

At operation 1700-2, the reception module 828 is configured to transmit at least one non-segmented PDU in the plurality of data packets by reconstructing at least one non-segmented PDU from one or more segmented PDUs at the RLC network layer to the PDCP network layer within a reassembly time.

In an embodiment of the disclosure, the first category of data packet with no transmission loss is received at the receiver 804. The PDUs with no segmentation performed at the transmitter 802 are received and transmitted to the PDCP network layer of the receiver for reassembly. The header for the RLC network layer may be removed before transmitting non-segmented packets to the PDCP network layer.

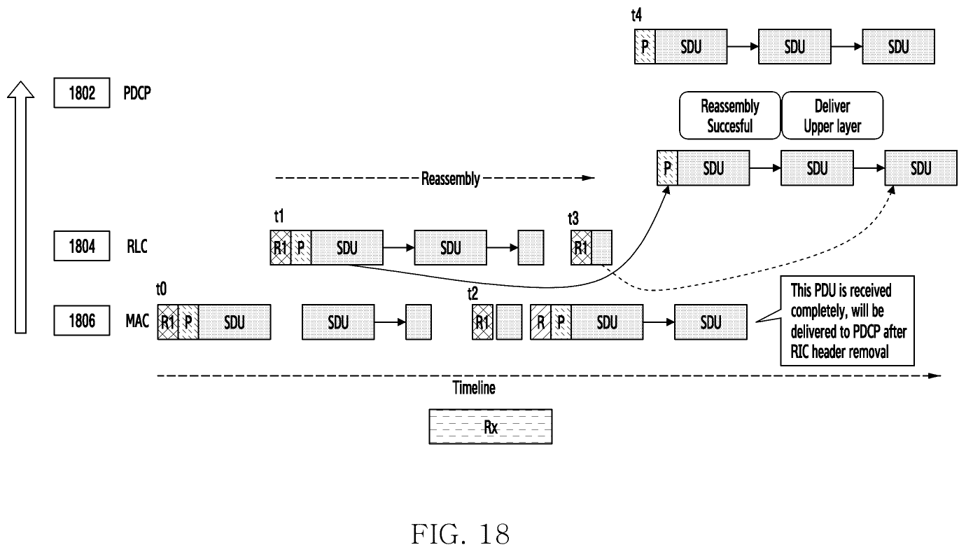

Further, a data packet with one or more segments and no transmission loss in the network may be received at the receiver 804. The segments are reassembled in a reassembly time and transmitted to the PDCP network layer. The description for process flow of FIG. 17 is further illustrated as schematic diagram for reassembly of data packets for lossless transmission in FIG. 18.

FIG. 18 illustrates a schematic diagram associated with a rearrangement of data packets at a receiver for no loss of data packets in a network according to an embodiment of the disclosure.

Referring to FIG. 18, the MAC network layer receives transport blocks at various TTI. At 1806, the MAC network layer parses the MAC sub-header and delivers the data packet to RLC network layer. At t=t0, a segmented PDU is received, while at t=t2, a complete PDU is received.

At 1804, the RLC network layer receives the data packets. The complete PDU, such as PDU at t=t2, (without segmentation) is transmitted to the PDCP network layer after removing the RLC header. RLC PDU, then they are delivered directly to PDCP. The segments are reassembled between t=t1 and t=t3, while waiting for receiving the remaining segment during the reassembly time (t1 to t3). For out of order segments, the reassembly timer starts, and the packet reassembly takes place for lossless transmission. At 1802, the PDCP network layer receives the PDUs and the reassembly is successful at t=t4, and the PDCP network layer delivers the PDUs to the upper network layer.

In the embodiment of the disclosure, the NR-UM is enabled for all scenarios at the RLC network layer and acknowledgement is not supported at the RLC network layer.

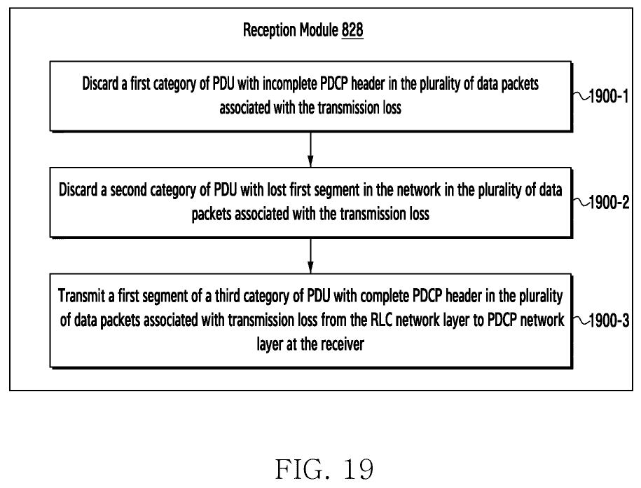

FIG. 19 illustrates a process flow diagram associated with a reception module to rearrange data packets at a receiver for loss of data packets in a network according to an embodiment of the disclosure.

Referring to FIG. 19, at operation 1900-1, the reception module 828 is configured to discard a first category of PDU with incomplete PDCP header in the plurality of data packets associated with the transmission loss.

At operation 1900-2, the reception module 828 is configured to discard a second category of PDU with the lost first segment in the network in the plurality of data packets associated with the transmission loss.

At operation 1900-3, the reception module 828 is configured to transmit a first segment of a third category of PDU with a complete PDCP header in the plurality of data packets associated with transmission loss from the RLC network layer to the PDCP network layer at the receiver.

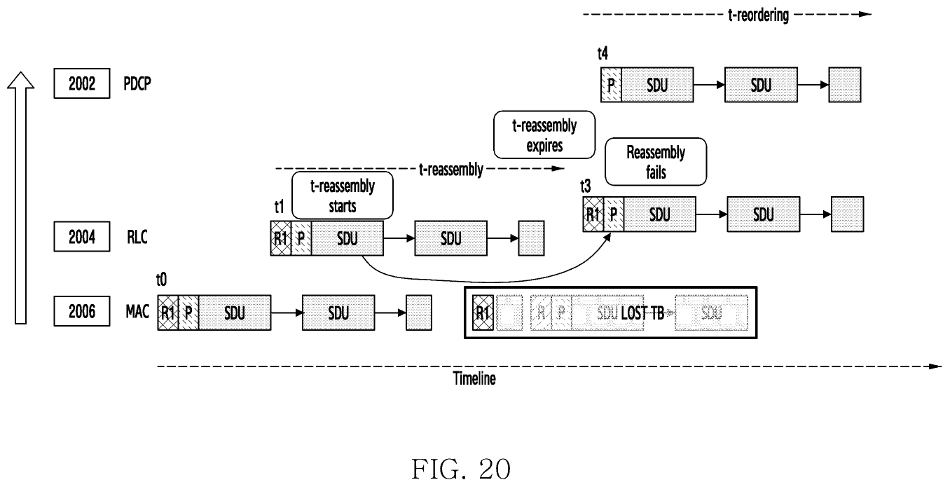

In an embodiment of the disclosure, the PDUs or data packets with incomplete PDCP header or lost first segment are discarded entirely and all segments are discarded. The PDUs or segments of PDUs not received within the reassembly time are also considered lost. The segments with complete PDCP header and received within reassembly time at the RLC network layer are transmitted to the PDCP network layer by the RLC network layer for status PDU generation to recover one or more segments lost during transmission. The description for process flow of FIG. 19 is further illustrated as schematic diagram for reassembly of data packets for lossless transmission in FIG. 20.

FIG. 20 illustrates a schematic diagram associated with a rearrangement of data packets at a receiver for loss of data packets in a network according to an embodiment of the disclosure.

Referring to FIG. 20, at 2006, the MAC network layer receives a segmented PDU at t=t0. FIG. 20 further illustrates a lost PDU or data packet. At 2008, the RLC network layer initiates reassembly at t=t1, and reassembly failed due to a lost data packet, or the data packet not being received within reassembly time from t1 to t3. Further, if PDCP header is detected at the RLC network layer, the segment with PDCP header is transmitted to the PDCP network layer to trigger status PDU generation for retransmission of data packets or segments of data packets lost.

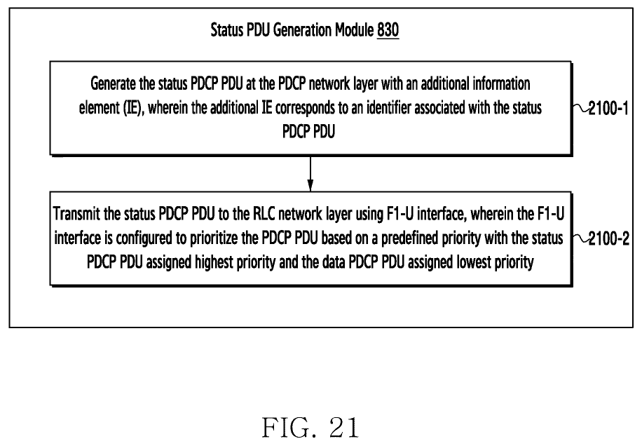

Further, in a scenario at 2002, if one or more PDCP PDUs are received at the PDCP network layer, the status PDU generation is triggered on the expiry of the reassembly timer. The process of status PDU generation and status PDU block diagram is illustrated in FIGS. 21 to 23.

FIG. 21 illustrates a process flow diagram associated with a status PDU generation module at a receiver according to an embodiment of the disclosure.

Referring to FIG. 21, at operation 2100-1, the status PDU generation module 830 is configured to generate the status PDCP PDU at the PDCP network layer with an additional information element (IE), wherein the additional IE corresponds to an identifier associated with the status PDCP PDU.

At operation 2100-2, the status PDU generation module 830 is configured to transmit the status PDCP PDU to the RLC network layer using the F1-U interface, wherein the F1-U interface is configured to prioritize the PDCP PDU based on a predefined priority with the status PDCP PDU assigned highest priority and the data PDCP PDU assigned lowest priority.

In an embodiment of the disclosure, the status PDU is generated for requesting retransmission of the lost data packets or lost segments of the data packets. The retransmission request may be further associated with data packets or segments of the data packets not received within reassembly time. The status PDU header structure contains an additional information element (IE).

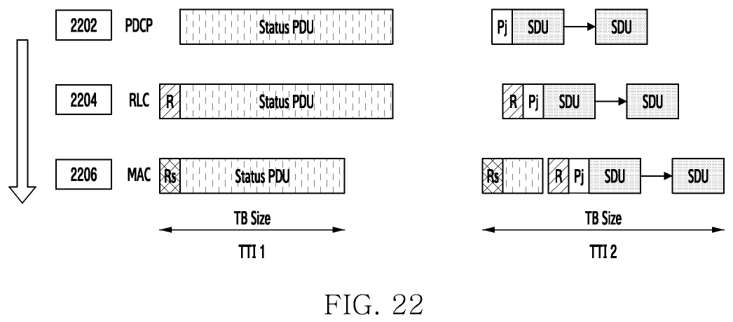

In the embodiment of the disclosure, the additional information element corresponds to CONTROL_SN. The status PDU header for the scenario is illustrated in FIG. 23 of the disclosure. FIG. 22 illustrates a schematic diagram where status PDU is segmented based on grant size and the CONTROL_SN may be used as identifier for segments of the status PDU.

FIG. 22 illustrates a schematic diagram associated with status PDU generation at a receiver according to an embodiment of the disclosure.

Referring to FIG. 22, at 2202, status PDU is generated at the PDCP network layer of the receiver 804. At 2204, the RLC network layer of the receiver 804 adds “R” as RLC header. At 2206, the grant size is lower compared to the size of the status PDU. The status PDU needs to be assigned an RLC SN for correct reassembly at the transmitter 802. The additional information element CONTROL_SN may be used as RLC SN for the segmented status PDU. The use of CONTROL_SN ensures that the RLC SN for the status PDU is different from the RLC SN for data PDUs. Further, the information regarding the status PDU may be conveyed over F1-U to the RLC network layer.

FIG. 23 illustrates a tabular representation of a sample header structure for a control packet for a PDCP status report required for an ARQ procedure according to an embodiment of the disclosure.

Referring to FIGS. 20 and 23, in case of data packet loss or out-of-order packet reception at the PDCP layer 2002, the PDCP network layer waits for the reassembly time. On expiry of reassembly time, the data packet is declared as lost and the PDCP network layer triggers a status PDU generation. The disclosure modifies the RLC network layer status PDU header for 5G NR and provides an additional IE in the status PDU header as CONTROL_SN. The CONTROL_SN may be of a size between 8 bits and 2 bits. The CONTROL_SN IE maintains the information of SN status PDU generated at the PDCP network layer. The CONTROL_SN IE allows segmentation and reassembly of the status PDU at the receiver and is useful in low grant scenarios. Furthermore, the CONTROL_SN IE allows for the interpretation of segmented status PDU in case a portion of the status PDU is lost.

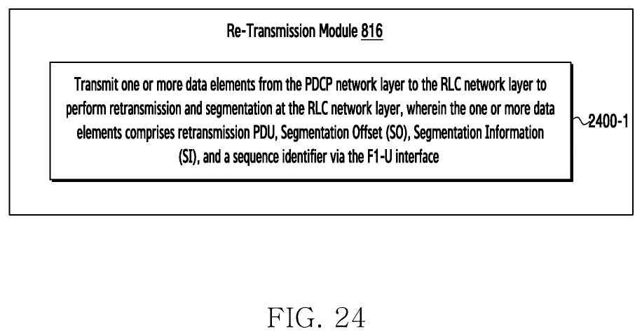

FIG. 24 illustrates a process flow associated with a re-transmission module for identical sequence number (SN) assigned to PDCP PDU and RLC PDU according to an embodiment of the disclosure.

Referring to FIG. 24, at operation 2400-1, the re-transmission module 816 may be configured to transmit one or more data elements from the PDCP network layer to the RLC network layer to perform retransmission and segmentation at the RLC network layer, wherein the one or more data elements comprises retransmission PDU, segmentation offset (SO), segmentation information (SI), and a sequence identifier via the F1-U interface.

In an embodiment of the disclosure, the RLC SN assigned at data PDU generation is same as the PDCP SN. Thus, the PDU identifier assigned at the PDCP and RLC network layer of the transmitter 802 are identical. In the embodiment of the disclosure, the RLC network layer performs segmentation. The PDCP network layer performs concatenation of SDUs, and reassembly of PDUs. The PDCP network layer further performs the functionality as per 5G NR, such as header compression, ciphering and integrity protection. Furthermore, the PDCP network layer is configured to perform transmission of three different PDUs i.e., the status PDU, retransmission PDU, and data PDU.

FIGS. 24 to 28 illustrate an implementation for RLC SN same as a PDCP SN. The additional advantage of configuring the RLC SN same as PDCP SN may be mentioned as the effective utilization of radio resources. Further, reassembly and recovery at the PDCP network layer eliminates redundancy with respect to communication overhead between PDCP and RLC network layers. In the embodiment of the disclosure, the retransmission is limited to the lost segment of PDU. The implementation is the same as provided in FIGS. 9A, 9B, 10 to 14, 15A, 15B, and 16 to 22 and an additional description is provided and illustrated in FIGS. 24 to 28 for an embodiment where RLC SN and PDCP SN are identical.

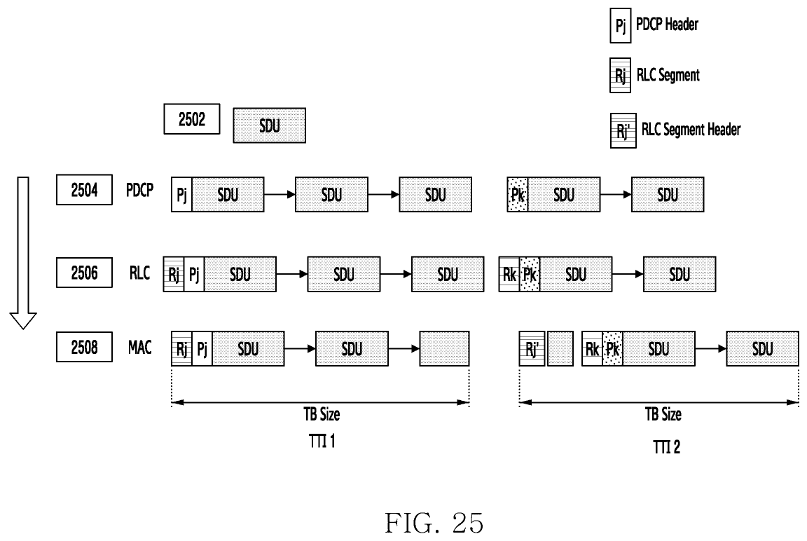

FIG. 25 illustrates a schematic diagram associated with a generation of PDU for a data plane processing at a transmitter for identical SN assigned to PDCP PDU and RLC PDU according to an embodiment of the disclosure.

Referring to FIG. 25, an SDU is illustrated at 2502 and at 2504 PDCP PDU is generated using SDUs and adding a PDCP header (Pj). At 2506, a header (Rj) is added to the PDCP PDU to generate the RLC PDU. At 2508, due to a lower grant, the RLC PDU is segmented and the RLC SN is assigned identical to the PDCP SN. The other implementation details are identical to those provided in FIGS. 9A and 9B and are not repeated for the sake of brevity.

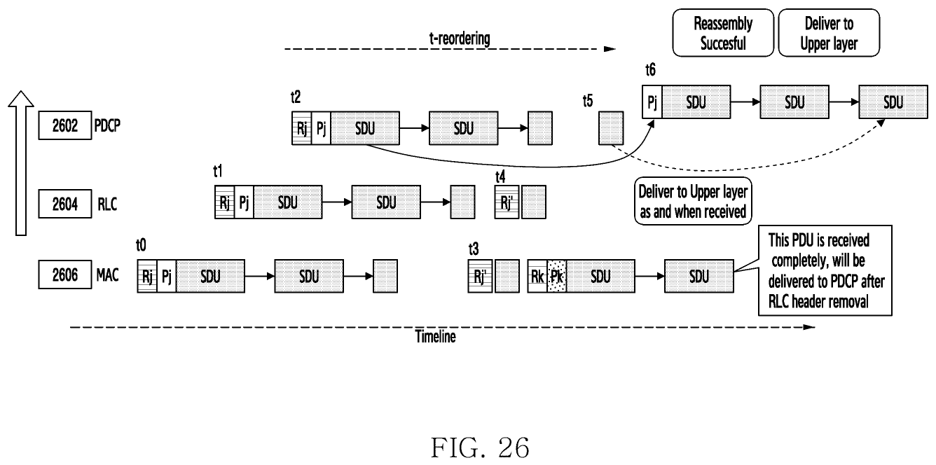

FIG. 26 illustrates a schematic diagram associated with a reassembly of data packets at a receiver for identical SN assigned to PDCP PDU and RLC PDU according to an embodiment of the disclosure.

Referring to FIG. 26, at 2606, data PDUs segments of data PDUs are received. The RLC network layer at 2604 performs header parsing and completely received PDUs are transmitted to the PDCP network layer. At 2602, the PDCP network layer performs the reassembly and reordering procedure. The other implementation details are identical to those provided with FIGS. 17 to 20 and not repeated for sake of brevity.

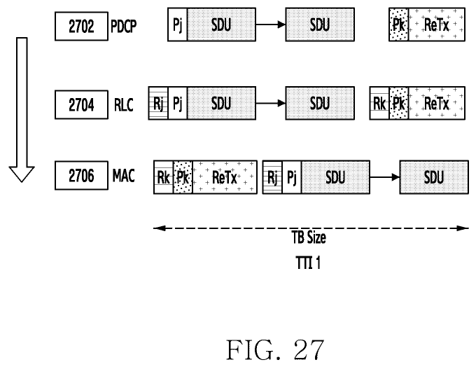

FIG. 27 illustrates a schematic diagram associated with retransmitting data packets at a transmitter for identical SN assigned to PDCP PDU and RLC PDU according to an embodiment of the disclosure.

Referring to FIG. 27, at 2702, a retransmission PDU from a single retransmission SDU is generated at the PDCP network layer. At 2704, the RLC network layer adds RLC header and at 2706, the MAC network layer prioritizes the retransmission PDU. In the figure, there is no segmentation of the retransmission PDU.

Further, in the embodiment of the disclosure, the information regarding the presence of retransmission PDU and SO, SI and SN should be conveyed over F1-U to the RLC network layer for prioritization of the retransmission PDU.

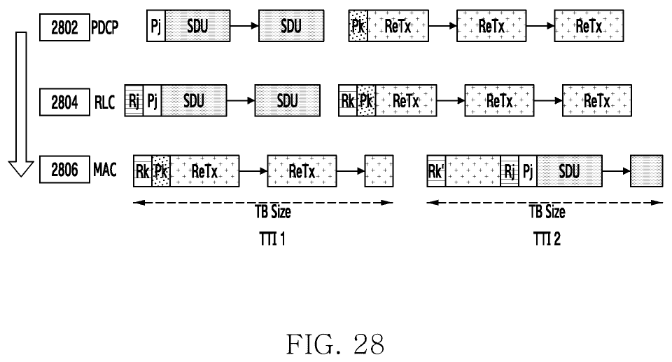

FIG. 28 illustrates a schematic diagram associated with retransmitting data packets at a transmitter for identical SN assigned to PDCP PDU and RLC PDU according to an embodiment of the disclosure.

Referring to FIG. 28, at 2802, the PDCP network layer generates a retransmission PDU from more than one retransmission SDU (ReTx). At 2804, the RLC network layer adds an RLC header to the retransmission PDU similar to the data PDUs. The RLC retransmission PDU exceeds the grant and segmentation of the retransmission PDU is performed. In the embodiment of the disclosure, RLC SN is assigned for the segmented retransmission PDU. Further, the retransmission PDU is assigned a higher priority compared to the data PDU as illustrated in the Figure.

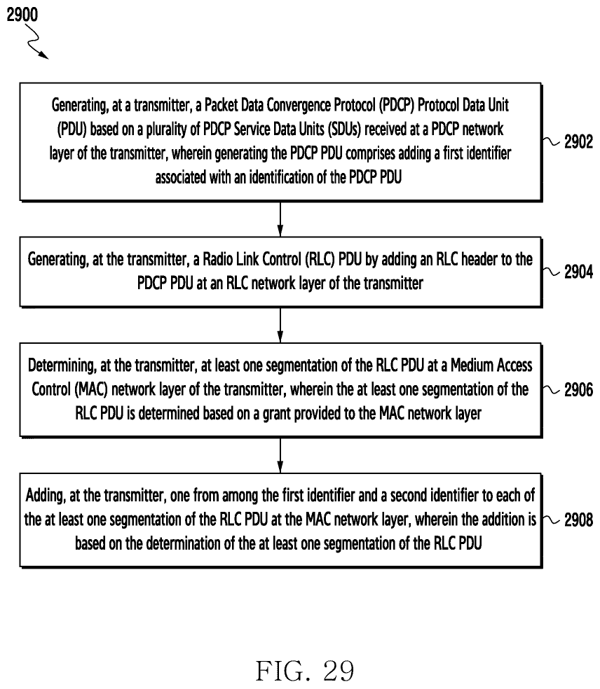

FIG. 29 illustrates n process flow comprising a method for optimizing a network protocol layer functionality of a network according to an embodiment of the disclosure.

Referring to FIG. 29, a method 2900 may be a computer-implemented method executed, for example, by the system 700, the transmitter 802, the receiver 804 and the modules 812 and 826. For the sake of brevity, the constructional and operational features of the system 700, the transmitter 802, the receiver 804 that are already explained in the description of FIGS. 1 to 4, 5A to 5C, 6 to 8, 9A, 9B, 10 to 14, 15A, 15B, and 16 to 28 are not explained in the description of FIG. 29.

At operation 2902, the method 2900 may include generating, at a transmitter, a packet data convergence protocol (PDCP) protocol data unit (PDU) based on a plurality of PDCP service data units (SDUs) received at PDCP network layer of the transmitter, wherein generating the PDCP PDU comprises adding a first identifier associated with identification of the PDCP PDU.

At operation 2904, the method 2900 may include generating, at the transmitter, a radio link control (RLC) PDU by adding an RLC header to the PDCP PDU at RLC network layer of the transmitter.

At operation 2906, the method 2900 may include determining, at the transmitter, at least one segmentation of the RLC PDU at the medium access control (MAC) network layer of the transmitter, wherein the at least one segmentation of the RLC PDU is determined based on a grant provided to the MAC network layer.

At operation 2908, the method 2900 may include adding, at the transmitter, one from among the first identifier and a second identifier to each of the at least one segmentation of the RLC PDU at the MAC network layer, wherein the addition is based on the determination of the at least one segmentation of the RLC PDU.

While the above-discussed operations in FIG. 29 are shown and described in a particular sequence, the operations may occur in variations to the sequence in accordance with various embodiments. Further, a detailed description related to the various operations of FIG. 29 is already covered in the description related to FIGS. 1 to 4, 5A to 5C, 6 to 8, 9A, 9B, 10 to 14, 15A, 15B, and 16 to 28 and is omitted herein for the sake of brevity.

The disclosure provides advantages by optimizing the functionality of network layers. The optimized functionality ensures meeting processing requirements associated with throughput and latency requirements. The optimizations in the functionality of the network layers may be highlighted as:
The present disclosure provides an optimized network protocol layer functionality and reduces the number of headers in the network protocol layer.
The present disclosure configures the RLC network layer to perform a segmentation procedure based on the transmission opportunity (grant) received from the MAC network layer to optimize network layer functionality.
The present disclosure configures the PDCP layer to perform packet concatenation to optimize network layer functionality.
The present disclosure assigns RLC SN only for data packets segmented at the MAC network layer, reducing redundancy in the data.
The present disclosure configures the receiver to perform status report generation for data packets lost or not received within reassembly time.
The present disclosure assigns priority to different PDUs, where status report PDU is assigned the highest priority followed by the retransmission PDU, and the transmission PDU is assigned the lowest priority. The priority is implemented by configuring interfaces such F1-U interface.
The present disclosure configures the RLC layer to perform segmentation of PDCP status report.
The present disclosure configures compression and ciphering to be performed for each PDCP SDU prior to generation of PDCP PDU form the SDUs.

According to an embodiment of the disclosure, a method performed by a transmitter, comprises generating a packet data convergence protocol (PDCP) protocol data unit (PDU) based on a plurality of PDCP service data units (SDUs), by adding a first identifier associated with an identification of the PDCP PDU, generating a radio link control (RLC) PDU by adding an RLC header to the PDCP PDU, determining at least one segmentation of the RLC PDU, wherein the at least one segmentation of the RLC PDU is determined based on a grant related to the RLC PDU, and adding, based on the determination of the at least one segmentation of the RLC PDU, one from among the first identifier and a second identifier to each of the at least one segmentation of the RLC PDU.

For example, generating the PDCP PDU further comprises performing a header compression for each of the plurality of PDCP SDUs, wherein the header compression is performed on a header corresponding to at least one of an Internet protocol (IP) header, a user datagram protocol (UDP) header, and a real-time transport protocol (RTP) header.

For example, generating the RLC PDU further comprises configuring a support for a new radio-unacknowledge mode (NR-UM), and configuring an absence of support for the new radio-acknowledge mode (NR-AM).

For example, the PDCP PDU comprises at least one of a status PDCP PDU, a retransmission PDCP PDU, and a data PDCP PDU.

For example, for retransmitting data packets associated with a transmission loss in the network, the method comprises at least one of receiving a status PDU associated with a first category of PDU, wherein the first category of PDU is associated with an incomplete PDCP header due to the transmission loss, receiving a status PDU associated with a second category of PDU, wherein the second category of PDU is associated with lost first segment due to the transmission loss, and receiving a status PDU associated with a third category of PDU, wherein the third category of PDU is associated with complete PDCP header and one or more lost segments due to the transmission loss.

For example, for retransmitting of the first category of PDU, the second category of PDU, and the third category of PDU, comprises retransmitting the first category of PDU and the second category of PDU as complete PDU, and retransmitting the third category of PDU as one or more lost segments of the complete PDU.

For example, for retransmitting of the first category of PDU, the second category of PDU, and the third category of PDU, further wherein the first identifier is added to each of the at least one segmentation of the RLC PDU during transmission from the transmitter, the method further comprises transmitting one or more data elements from a PDCP network layer to a RLC network layer to perform retransmission and segmentation at the RLC network layer, wherein the one or more data elements comprises a retransmission PDU, a segmentation offset (SO), a segmentation information (SI), and a sequence identifier via an F1-U interface.

According to an embodiment of the disclosure, a method performed by a receiver, comprises receiving a first category of data packets associated with a lossless transmission from a transmitter, receiving a second category of data packets associated with a transmission loss from the transmitter, performing reassembly of a PDCP PDU at a PDCP network layer based on the received first category of data packets and the received second category of data packets, and generating a status PDCP PDU at the PDCP network layer for the second category of data packets.

For example, for receiving the first category of data packets associated with the lossless transmission from the transmitter, the method comprises transmitting one or more non-segmented PDUs in the plurality of data packets by a RLC network layer to a PDCP network layer, and transmitting at least one non-segmented PDU in the plurality of data packets by reconstructing at least one non-segmented PDU from one or more segmented PDUs at the RLC network layer to the PDCP network layer within a reassembly time.

For example, for receiving the second category of data packets from the transmitter associated with the transmission loss from the baes station, the method comprises discarding a first category of PDU with incomplete PDCP header in the plurality of data packets associated with the transmission loss, discarding a second category of PDU with a lost first segment in the network in the plurality of data packets associated with the transmission loss, and transmitting a first segment of a third category of PDU with a complete PDCP header in the plurality of data packets associated with transmission loss from a RLC network layer to a PDCP network layer.

For example, for generating the status PDCP PDU, the method comprises generating the status PDCP PDU with an additional information element (IE), wherein the additional IE corresponds to an identifier associated with the status PDCP PDU, and transmitting the status PDCP PDU to a RLC network layer using an F1-U interface, wherein the F1-U interface is configured to prioritize the PDCP PDU based on a predefined priority with the status PDCP PDU assigned a highest priority and the data PDCP PDU assigned a lowest priority.

According to an embodiment of the disclosure, a transmitter comprises a transceiver, memory storing one or more instructions, comprising one or more storage media, and at least one processor comprising processing circuitry. The instructions, when executed by the at least one processor individually or collectively, cause the transmitter to generate a packet data convergence protocol (PDCP) protocol data unit (PDU) based on a plurality of PDCP service data units (SDUs), by adding a first identifier associated with an identification of the PDCP PDU, generate a radio link control (RLC) PDU by adding an RLC header to the PDCP PDU, determine at least one segmentation of the RLC PDU, wherein the at least one segmentation of the RLC PDU is determined based on a grant related to the RLC PDU, and add, based on the determination of the at least one segmentation of the RLC PDU, one from among the first identifier and a second identifier to each of the at least one segmentation of the RLC PDU.

For example, the instructions, when executed by the at least one processor individually or collectively, cause the transmitter to perform a header compression for each of the plurality of PDCP SDUs. The header compression is performed on a header corresponding to at least one of an Internet protocol (IP) header, a user datagram protocol (UDP) header, and a real-time transport protocol (RTP) header.

For example, the instructions, when executed by the at least one processor individually or collectively, cause the transmitter to configure a support for a new radio-unacknowledge mode (NR-UM), and configure an absence of support for the new radio-acknowledge mode (NR-AM).

For example, the PDCP PDU comprises at least one of a status PDCP PDU, a retransmission PDCP PDU, and a data PDCP PDU.

According to an embodiment of the disclosure, a method for optimizing network protocol layer functionality of a network, comprises generating, at a transmitter, a packet data convergence protocol (PDCP) protocol data unit (PDU) based on a plurality of PDCP service data units (SDUs) received at a PDCP network layer of the transmitter, wherein generating the PDCP PDU comprises adding a first identifier associated with an identification of the PDCP PDU, generating, at the transmitter, a radio link control (RLC) PDU by adding an RLC header to the PDCP PDU at an RLC network layer of the transmitter, determining, at the transmitter, at least one segmentation of the RLC PDU at a medium access control (MAC) network layer of the transmitter, wherein the at least one segmentation of the RLC PDU is determined based on a grant provided to the MAC network layer, and adding, at the transmitter, one from among the first identifier and a second identifier to each of the at least one segmentation of the RLC PDU at the MAC network layer, wherein the addition is based on the determination of the at least one segmentation of the RLC PDU.

For example, generating at the transmitter the PDCP PDU further comprises performing a header compression for each of the plurality of PDCP SDUs, wherein the header compression is performed on a header corresponding to at least one of an Internet protocol (IP) header, a user datagram protocol (UDP) header, and a real-time transport protocol (RTP) header.

For example, generating the RLC PDU at the transmitter further comprises configuring a support for a new radio-unacknowledge mode (NR-UM) at the RLC network layer, and configuring an absence of support for the new radio-acknowledge mode (NR-AM) at the RLC network layer.

For example, the PDCP PDU is at least one of a status PDCP PDU, a retransmission PDCP PDU, and a data PDCP PDU.

For example, for retransmitting data packets associated with a transmission loss in the network, the method comprises at least one of receiving, at the transmitter, a status PDU associated with a first category of PDU, wherein the first category of PDU is associated with an incomplete PDCP header due to the transmission loss, receiving, at the transmitter, a status PDU associated with a second category of PDU, wherein the second category of PDU is associated with lost first segment due to the transmission loss, and receiving, at the transmitter, a status PDU associated with a third category of PDU, wherein the third category of PDU is associated with complete PDCP header and one or more lost segments due to the transmission loss.

For example, for retransmitting of the first category of PDU, the second category of PDU, and the third category of PDU at the transmitter, the method comprises retransmitting, by the PDCP network layer at the transmitter, the first category of PDU and the second category of PDU, wherein the PDCP network layer retransmits the first category of PDU and the second category of PDU completely, and retransmitting, by the PDCP network layer at the transmitter, the third category of PDU, wherein the PDCP network layer retransmits one or more lost segments of the complete PDU.

For example, for retransmitting of the first category of PDU, the second category of PDU, and the third category of PDU, further wherein the first identifier is added to each of the at least one segmentation of the RLC PDU during transmission from the transmitter, the method further comprises: transmitting, at the transmitter, one or more data elements from the PDCP network layer to the RLC network layer to perform retransmission and segmentation at the RLC network layer, wherein the one or more data elements comprises a retransmission PDU, a segmentation offset (SO), a segmentation information (SI), and a sequence identifier via an F1-U interface.

According to an embodiment of the disclosure, a method for optimizing network protocol layer functionality of a network, comprises receiving, at a receiver, a first category of data packets associated with a lossless transmission from the transmitter, receiving, at the receiver, a second category of data packets associated with a transmission loss from the transmitter, performing, at the receiver, reassembly of a PDCP PDU at a PDCP network layer based on the received first category of data packets and the received second category of data packets, and generating, at the receiver, a status PDCP PDU at the PDCP network layer for the second category of data packets.

For example, for receiving at a receiver the first category of data packets associated with the lossless transmission from the transmitter, the method comprises transmitting, at the receiver, one or more non-segmented PDUs in the plurality of data packets by the RLC network layer to the PDCP network layer, and transmitting, at the receiver, at least one non-segmented PDU in the plurality of data packets by reconstructing at least one non-segmented PDU from one or more segmented PDUs at the RLC network layer to the PDCP network layer within a reassembly time.

For example, for receiving at the receiver the second category of data packets from the transmitter associated with the transmission loss from the transmitter, the method comprises discarding, at the receiver, a first category of PDU with incomplete PDCP header in the plurality of data packets associated with the transmission loss, discarding, at the receiver, a second category of PDU with a lost first segment in the network in the plurality of data packets associated with the transmission loss, and transmitting, at the receiver, a first segment of a third category of PDU with a complete PDCP header in the plurality of data packets associated with transmission loss from the RLC network layer to the PDCP network layer at the receiver.

For example, for generating the status PDCP PDU at the PDCP network layer at the receiver, the method comprises generating, at the receiver, the status PDCP PDU at the PDCP network layer with an additional information element (IE), wherein the additional IE corresponds to an identifier associated with the status PDCP PDU, and transmitting, at the receiver, the status PDCP PDU to the RLC network layer using an F1-U interface, wherein the F1-U interface is configured to prioritize the PDCP PDU based on a predefined priority with the status PDCP PDU assigned a highest priority and the data PDCP PDU assigned a lowest priority.

According to an embodiment of the disclosure, a system to optimize network protocol layer functionality of a network, comprises memory, a communicator, and a processor, operably connected to the memory and the communicator, the system is configured to generate a packet data convergence protocol (PDCP) protocol data unit (PDU) based on a plurality of PDCP service data units (SDUs) received at a PDCP network layer of the transmitter, wherein generating the PDCP PDU comprises adding a first identifier associated with an identification of the PDCP PDU, generate a radio link control (RLC) PDU by adding an RLC header to the PDCP PDU at an RLC network layer of the transmitter, determine at least one segmentation of the RLC PDU at a medium access control (MAC) network layer of the transmitter, wherein the at least one segmentation of the RLC PDU is determined based on a grant provided to the MAC network layer, and add one from among the first identifier and a second identifier to each of the at least one segmentation of the RLC PDU at the MAC network layer, wherein the addition is based on the determination of the at least one segmentation of the RLC PDU.

For example, to generate at the transmitter the PDCP PDU, the system is further configured to perform a header compression for each of the plurality of PDCP SDUs, wherein the header compression is performed on a header corresponding to at least one of an Internet protocol (IP) header, a user datagram protocol (UDP) header, and a real-time transport protocol (RTP) header.

For example, to generate the RLC PDU at the transmitter the system is further configured to configure a support for a new radio-unacknowledge mode (NR-UM) at the RLC network layer, and configure an absence of support for the new radio-acknowledge mode (NR-AM) at the RLC network layer.

For example, the PDCP PDU is at least one of a status PDCP PDU, a retransmission PDCP PDU, and a data PDCP PDU.

For example, to retransmit data packets associated with a transmission loss in the network, the system is configured to perform at least one of receive a status PDU associated with a first category of PDU, wherein the first category of PDU is associated with an incomplete PDCP header due to the transmission loss, receive a status PDU associated with a second category of PDU, wherein the second category of PDU is associated with lost first segment due to the transmission loss, and receive a status PDU associated with a third category of PDU, wherein the third category of PDU is associated with complete PDCP header and one or more lost segments due to the transmission loss.

For example, to retransmit the first category of PDU, the second category of PDU, and the third category of PDU at the transmitter, the system is configured to retransmit the first category of PDU and the second category of PDU, wherein the PDCP network layer retransmits the first category of PDU and the second category of PDU completely, and retransmit the third category of PDU, wherein the PDCP network layer retransmits one or more lost segments of the complete PDU.

For example, to retransmit the first category of PDU, the second category of PDU, and the third category of PDU, further wherein the first identifier is added to each of the at least one segmentation of the RLC PDU during transmission from the transmitter, the system is further configured to transmit one or more data elements from the PDCP network layer to the RLC network layer to perform retransmission and segmentation at the RLC network layer, wherein the one or more data elements comprises a retransmission PDU, a segmentation offset (SO), a segmentation information (SI), and a sequence identifier via an F1-U interface.

For example, a system to optimize network protocol layer functionality of a network, comprises memory, a communicator, and a processor, operably connected to the memory and the communicator. The system is configured to receive a first category of data packets associated with lossless transmission from the transmitter, receive a second category of data packets associated with a transmission loss from the transmitter, perform reassembly of a PDCP PDU at a PDCP network layer based on the received first category of data packets and the received second category of data packets, and generate a status PDCP PDU at the PDCP network layer for the second category of data packets.

For example, to receive at a receiver the first category of data packets associated with the lossless transmission from the transmitter, the system is configured to transmit one or more non-segmented PDUs in the plurality of data packets by the RLC network layer to the PDCP network layer, and transmit at least one non-segmented PDU in the plurality of data packets by reconstructing at least one non-segmented PDU from one or more segmented PDUs at the RLC network layer to the PDCP network layer within a reassembly time.

For example, to receive at the receiver the second category of data packets from the transmitter associated with the transmission loss from the transmitter, the system is configured to discard a first category of PDU with incomplete PDCP header in the plurality of data packets associated with the transmission loss, discard a second category of PDU with a lost first segment in the network in the plurality of data packets associated with the transmission loss, and transmit a first segment of a third category of PDU with a complete PDCP header in the plurality of data packets associated with transmission loss from the RLC network layer to the PDCP network layer at the receiver.

For example, to generate the status PDCP PDU at the PDCP network layer at the receiver, the system is configured to generate the status PDCP PDU at the PDCP network layer with an additional information element (IE), wherein the additional IE corresponds to an identifier associated with the status PDCP PDU, and transmit the status PDCP PDU to the RLC network layer using an F1-U interface, wherein the F1-U interface is configured to prioritize the PDCP PDU based on a predefined priority with the status PDCP PDU assigned a highest priority and the data PDCP PDU assigned a lowest priority.

For one or more embodiments of the disclosure, at least one of the components set forth in one or more of the preceding figures may be configured to perform one or more operations, techniques, processes, and/or methods as set forth herein. For example, a processor (e.g., baseband processor) as described herein in connection with one or more of the preceding figures may be configured to operate in accordance with one or more of the examples set forth herein. For another example, circuitry associated with a UE, transmitter, network element, etc. as described above in connection with one or more of the preceding figures may be configured to operate in accordance with one or more of the examples set forth herein.

Any of the above described embodiments may be combined with any other embodiment (or combination of embodiments), unless explicitly stated otherwise. The foregoing description of one or more implementations provides illustration and description, but is not intended to be exhaustive or to limit the scope of embodiments to the precise form disclosed. Modifications and variations are possible in light of the above teachings or may be acquired from practice of various embodiments.

The methods according to various embodiments described in the claims and/or the specification of the disclosure may be implemented in hardware, software, or a combination of hardware and software.

When implemented by software, a computer-readable storage medium storing one or more programs (software modules) may be provided. One or more programs stored in such a computer-readable storage medium (e.g., non-transitory storage medium) are configured for execution by one or more processors in an electronic device. The one or more programs include instructions that cause the electronic device to execute the methods according to embodiments described in the claims or specification of the disclosure.

Such a program (e.g., software module, software) may be stored in random-access memory, non-volatile memory including flash memory, read only memory (ROM), electrically erasable programmable read only memory (EEPROM), magnetic disc storage device, compact disc-ROM (CD-ROM), digital versatile discs (DVDs), other types of optical storage devices, or magnetic cassettes. Alternatively, it may be stored in memory configured with a combination of some or all of the above. In addition, respective constituent memories may be provided in a multiple number.

Further, the program may be stored in an attachable storage device that can be accessed via a communication network, such as e.g., Internet, Intranet, local area network (LAN), wide area network (WAN), or storage area network (SAN), or a communication network configured with a combination thereof. Such a storage device may access an apparatus performing an embodiment of the disclosure through an external port. Further, a separate storage device on the communication network may be accessed to an apparatus performing an embodiment of the disclosure.

In the above-described specific embodiments of the disclosure, a component included therein may be expressed in a singular or plural form according to a proposed specific embodiment. However, such a singular or plural expression may be selected appropriately for the presented context for the convenience of description, and the disclosure is not limited to the singular form or the plural elements. Therefore, either an element expressed in the plural form may be formed of a singular element, or an element expressed in the singular form may be formed of plural elements.

Meanwhile, specific embodiments have been described in the detailed description of the disclosure, but it goes without saying that various modifications are possible without departing from the scope of the disclosure.

While specific language has been used to describe the disclosure, any limitations arising on account of the same are not intended. As would be apparent to a person in the art, various working modifications may be made to the method in order to implement the inventive concept as taught herein.

The drawings and the forgoing description give examples of embodiments. Those skilled in the art will appreciate that one or more of the described elements may well be combined into a single functional element. Alternatively, certain elements may be split into multiple functional elements. Elements from one embodiment may be added to another embodiment. For example, orders of processes described herein may be changed and are not limited to the manner described herein.

Moreover, the actions of any flow diagram need not be implemented in the order shown; nor do all of the acts necessarily need to be performed. In addition, those acts that are not dependent on other acts may be performed in parallel with the other acts. The scope of embodiments is by no means limited by these specific examples. Numerous variations, whether explicitly given in the specification or not, such as differences in structure, dimension, and use of material, are possible. The scope of embodiments is at least as broad as given by the following claims.

It will be appreciated that various embodiments of the disclosure according to the claims and description in the specification can be realized in the form of hardware, software or a combination of hardware and software.

Any such software may be stored in non-transitory computer readable storage media. The non-transitory computer readable storage media store one or more computer programs (software modules), the one or more computer programs include computer-executable instructions that, when executed by one or more processors of an electronic device, cause the electronic device to perform a method of the disclosure.

Any such software may be stored in the form of volatile or non-volatile storage, such as, for example, a storage device like read only memory (ROM), whether erasable or rewritable or not, or in the form of memory, such as, for example, random access memory (RAM), memory chips, device or integrated circuits or on an optically or magnetically readable medium, such as, for example, a compact disk (CD), digital versatile disc (DVD), magnetic disk or magnetic tape or the like. It will be appreciated that the storage devices and storage media are various embodiments of non-transitory machine-readable storage that are suitable for storing a computer program or computer programs comprising instructions that, when executed, implement various embodiments of the disclosure. Accordingly, various embodiments provide a program comprising code for implementing apparatus or a method of any one of the claims of this specification and a non-transitory machine-readable storage storing such a program.

White the disclosure has been shown and described with reference to various embodiments thereof, it will be understood by those skilled in the art that various changes in form and details may be made therein without departing from the spirit and scope of the disclosure as defined by the appended claims and their equivalents.

What is claimed is:

1. A method performed by a transmitter, the method comprising:
generating a packet data convergence protocol (PDCP) protocol data unit (PDU) based on a plurality of PDCP service data units (SDUs), by adding a first identifier associated with an identification of the PDCP PDU;
generating a radio link control (RLC) PDU by adding an RLC header to the PDCP PDU;
determining at least one segmentation of the RLC PDU, wherein the at least one segmentation of the RLC PDU is determined based on a grant related to the RLC PDU; and
adding, based on the determination of the at least one segmentation of the RLC PDU, one from among the first identifier and a second identifier to each of the at least one segmentation of the RLC PDU.

2. The method of claim 1, wherein the generating of the PDCP PDU further comprises:
performing a header compression for each of the plurality of PDCP SDUs, wherein the header compression is performed on a header corresponding to at least one of an Internet protocol (IP) header, a user datagram protocol (UDP) header, and a real-time transport protocol (RTP) header.

3. The method of claim 1, wherein the generating of the RLC PDU further comprises:
configuring a support for a new radio-unacknowledge mode (NR-UM); and
configuring an absence of support for new radio-acknowledge mode (NR-AM).

4. The method of claim 1, wherein the PDCP PDU comprises at least one of a status PDCP PDU, a retransmission PDCP PDU, and a data PDCP PDU.

5. The method of claim 1, wherein, for retransmitting data packets associated with a transmission loss in a network, the method comprises at least one of:
receiving a status PDU associated with a first category of PDU, wherein the first category of PDU is associated with an incomplete PDCP header due to the transmission loss;
receiving a status PDU associated with a second category of PDU, wherein the second category of PDU is associated with lost first segment due to the transmission loss; and
receiving a status PDU associated with a third category of PDU, wherein the third category of PDU is associated with complete PDCP header and one or more lost segments due to the transmission loss.

6. The method of claim 5, wherein, for retransmitting of the first category of PDU, the second category of PDU, and the third category of PDU, the method comprises:
retransmitting the first category of PDU and the second category of PDU as complete PDU; and
retransmitting the third category of PDU as one or more lost segments of the complete PDU.

7. The method of claim 5, wherein, for retransmitting of the first category of PDU, the second category of PDU, and the third category of PDU, further wherein the first identifier is added to each of the at least one segmentation of the RLC PDU during transmission from the transmitter, the method further comprises:
transmitting one or more data elements from a PDCP network layer to a RLC network layer to perform retransmission and segmentation at the RLC network layer, wherein the one or more data elements comprises a retransmission PDU, a segmentation offset (SO), a segmentation information (SI), and a sequence identifier via an F1-U interface.

8. A method performed by a receiver, the method comprising:
receiving a first category of data packets associated with a lossless transmission from a transmitter;
receiving a second category of data packets associated with a transmission loss from the transmitter;
performing reassembly of a packet data convergence protocol (PDCP) protocol data unit (PDU) at a PDCP network layer based on the received first category of data packets and the received second category of data packets; and
generating a status PDCP PDU at the PDCP network layer for the second category of data packets.

9. The method of claim 8, wherein, for receiving the first category of data packets associated with the lossless transmission from the transmitter, the method comprises:
transmitting one or more non-segmented PDUs in a plurality of data packets by a radio link control (RLC) network layer to a PDCP network layer; and
transmitting at least one non-segmented PDU in the plurality of data packets by reconstructing at least one non-segmented PDU from one or more segmented PDUs at the RLC network layer to the PDCP network layer within a reassembly time.

10. The method of claim 9, wherein, for receiving the second category of data packets from the transmitter associated with the transmission loss from a base station, the method comprises:
discarding a first category of PDU with incomplete PDCP header in the plurality of data packets associated with the transmission loss;
discarding a second category of PDU with a lost first segment in a network in the plurality of data packets associated with the transmission loss; and
transmitting a first segment of a third category of PDU with a complete PDCP header in the plurality of data packets associated with transmission loss from a RLC network layer to a PDCP network layer.

11. The method of claim 8, wherein, for generating the status PDCP PDU, the method comprises:
generating the status PDCP PDU with an additional information element (IE), wherein the additional IE corresponds to an identifier associated with the status PDCP PDU; and
transmitting the status PDCP PDU to a RLC network layer using an F1-U interface, wherein the F1-U interface is configured to prioritize the PDCP PDU based on a predefined priority with the status PDCP PDU assigned a highest priority and the data PDCP PDU assigned a lowest priority.

12. A transmitter comprising:
a transceiver;
memory, comprising one or more storage media, storing instructions; and
at least one processor comprising processing circuitry,
wherein the instructions, when executed by the at least one processor individually or collectively, cause the transmitter to:
generate a packet data convergence protocol (PDCP) protocol data unit (PDU) based on a plurality of PDCP service data units (SDUs), by adding a first identifier associated with an identification of the PDCP PDU,
generate a radio link control (RLC) PDU by adding an RLC header to the PDCP PDU,
determine at least one segmentation of the RLC PDU, wherein the at least one segmentation of the RLC PDU is determined based on a grant related to the RLC PDU, and
add, based on the determination of the at least one segmentation of the RLC PDU, one from among the first identifier and a second identifier to each of the at least one segmentation of the RLC PDU.

13. The transmitter of claim 12, wherein the instructions, when executed by the at least one processor individually or collectively, further cause the transmitter to:
perform a header compression for each of the plurality of PDCP SDUs, wherein the header compression is performed on a header corresponding to at least one of an Internet protocol (IP) header, a user datagram protocol (UDP) header, and a real-time transport protocol (RTP) header.

14. The transmitter of claim 13, wherein the instructions, when executed by the at least one processor individually or collectively, further cause the transmitter to:
configure a support for a new radio-unacknowledge mode (NR-UM), and
configure an absence of support for new radio-acknowledge mode (NR-AM).

15. The transmitter of claim 13, wherein the PDCP PDU comprises at least one of a status PDCP PDU, a retransmission PDCP PDU, and a data PDCP PDU.

16. The transmitter of claim 12, wherein the instructions, when executed by the at least one processor individually or collectively, further cause the transmitter to:
receive a status PDU associated with a first category of PDU, wherein the first category of PDU is associated with an incomplete PDCP header due to a transmission loss,
receive a status PDU associated with a second category of PDU, wherein the second category of PDU is associated with lost first segment due to the transmission loss, and
receive a status PDU associated with a third category of PDU, wherein the third category of PDU is associated with complete PDCP header and one or more lost segments due to the transmission loss.

17. The transmitter of claim 16, wherein the instructions, when executed by the at least one processor individually or collectively, further cause the transmitter to:
retransmit the first category of PDU and the second category of PDU as complete PDU, and
retransmit the third category of PDU as one or more lost segments of the complete PDU.

18. The transmitter of claim 16, wherein the instructions, when executed by the at least one processor individually or collectively, further cause the transmitter to:
transmit one or more data elements from a PDCP network layer to a RLC network layer to perform retransmission and segmentation at the RLC network layer, wherein the one or more data elements comprises a retransmission PDU, a segmentation offset (SO), a segmentation information (SI), and a sequence identifier via an F1-U interface.

19. One or more non-transitory computer-readable storage media storing one or more computer programs including computer-executable instruction that, when executed by one or more processors of a transmitter individually or collectively, cause the transmitter to perform operations, the operations comprising:
generating a packet data convergence protocol (PDCP) protocol data unit (PDU) based on a plurality of PDCP service data units (SDUs), by adding a first identifier associated with an identification of the PDCP PDU;
generating a radio link control (RLC) PDU by adding an RLC header to the PDCP PDU;
determining at least one segmentation of the RLC PDU, wherein the at least one segmentation of the RLC PDU is determined based on a grant related to the RLC PDU; and
adding, based on the determination of the at least one segmentation of the RLC PDU, one from among the first identifier and a second identifier to each of the at least one segmentation of the RLC PDU.

20. The one or more non-transitory computer-readable storage media of claim 19, wherein the generating of the PDCP PDU further comprises:
performing a header compression for each of the plurality of PDCP SDUs, wherein the header compression is performed on a header corresponding to at least one of an Internet protocol (IP) header, a user datagram protocol (UDP) header, and a real-time transport protocol (RTP) header.
